(19) United States
(12) Patent Application Publication
(10) Pub. No.: US 2025/0018321 A1
(43) Pub. Date: Jan. 16, 2025

(54) MECHANICAL INTERLOCK SYSTEM FOR A FILTER

(71) Applicant: ELECTROLUX CONSUMER PRODUCTS, INC., Charlotte, NC (US)

(72) Inventors: Marcello Correa Machado, Anderson, SC (US); Jeremy Carlton Bowyer, Anderson, SC (US); Thomas W. McCollough, Anderson, SC (US)

(73) Assignee: ELECTROLUX CONSUMER PRODUCTS, INC., Charlotte, NC (US)

(21) Appl. No.: 18/899,978

(22) Filed: Sep. 27, 2024

Related U.S. Application Data
(63) Continuation-in-part of application No. 18/243,286, filed on Sep. 7, 2023.
Application No. 18/243,286 is a continuation of application No. 17/333,124, filed on May 28, 2021, now Pat. No. 11,779,867.
(60) Provisional application No. 63/541,316, filed on Sep. 29, 2023.
(60) Provisional application No. 63/604,579, filed on Nov. 30, 2023.

(51) Int. Cl. B01D 35/30; B01D 35/02

(52) U.S. Cl. CPC B01D 35/306; B01D 35/02; B01D 2201/29; B01D 2201/4053

(57) ABSTRACT

A mechanical interlock system for a fluid filter is described herein. The mechanical interlock system may include a filter cartridge and a manifold for receiving the filter cartridge. The filter cartridge may include a filter body, a fluid inlet and outlet, and an integrated locking head. The integrated locking head may include a key extending radially outward from the integrated locking head and displaceable latch features. The manifold may include an extraction guide for receiving the key. The extraction guide may include a primary keyway and a secondary keyway. The key, keyways, displaceable latch features, and/or receptacles may interact to maintain alignment of the filter cartridge during insertion of the filter cartridge into an appliance including the manifold.

### CROSS-REFERENCE TO RELATED APPLICATIONS

This application claims the benefit of priority to U.S. Provisional Patent Application Ser. No. 63/541,316, filed Sep. 29, 2023, titled MECHANICAL INTERLOCK SYSTEM FOR A FILTER, U.S. Provisional Patent Application Ser. No. 63/604,579, filed Nov. 30, 2023, titled MECHANICAL INTERLOCK SYSTEM FOR A FILTER, and U.S. Non-Provisional patent application Ser. No. 18/243,286, filed Sep. 7, 2023, titled MECHANICAL INTERLOCK SYSTEM FOR A FILTER, which claims the benefit of priority to U.S. patent application Ser. No. 17/333,124, filed May 28, 2021, now U.S. Pat. No. 11,779,867. Each of the foregoing patent applications and patent is hereby incorporated by reference in its entirety.

### FIELD

The present disclosure embraces a mechanical interlock system for a fluid filter, such as a water filter in an appliance (e.g., food refrigeration appliances, cooking appliances, fabric care appliances, and/or the like).

### BACKGROUND

Appliances, such as food refrigeration appliances, cooking appliances, fabric care appliances, and/or the like, may include one or more components, such as a water dispenser, an ice maker, and/or the like, which use water from a water supply (e.g., a household water supply and/or the like). Such appliances typically include a water filter that filters water received from the water supply before the water is provided to the one or more components. Such water filters have a useful lifespan that is shorter than the appliance and must be replaced for the appliance to continue to provide properly filtered water. Appliances typically include an opening to permit a user to remove an expired water filter and install a replacement water filter.

### SUMMARY

The following presents a simplified summary of one or more embodiments of the present disclosure, in order to provide a basic understanding of such embodiments. This summary is not an extensive overview of all contemplated embodiments, and is intended to neither identify key or critical elements of all embodiments nor delineate the scope of any or all embodiments. This summary presents some concepts of one or more embodiments of the present disclosure in a simplified form as a prelude to the more detailed description that is presented later.

In one aspect, the present disclosure embraces a mechanical interlock system, which may include a filter cartridge and a manifold for receiving the filter cartridge (e.g., a filter cartridge manifold). The filter cartridge may include a filter body having a first end, a second end, and a longitudinal axis, a fluid inlet and outlet at the first end of the filter body, and an integrated locking head on the first end of the filter body. The integrated locking head may include a key extending radially outward from the integrated locking head, and at least one displaceable latch feature extending longitudinally from the locking head. The manifold which may include at least one receptacle on an inner surface of the manifold, each of the at least one receptacle structured for receiving the at least one displaceable latch feature, preventing rotation of the filter cartridge in a first direction, and permitting rotation of the filter cartridge in a second direction. The manifold may include an extraction guide for receiving the key. The extraction guide may include a primary keyway, and a secondary keyway, wherein the secondary keyway has an entry end and an exit end, and wherein the exit end of the secondary keyway connects to the primary keyway. The at least one receptacle may be structured to prevent, after the at least one displaceable latch feature has been received by the at least one receptacle, movement of the filter cartridge in a direction along the longitudinal axis that is opposite an insertion direction, prevent rotation of the filter cartridge in the first direction, and permit rotation of the filter cartridge in the second direction.

In some embodiments, during insertion of the filter cartridge into the manifold, the key passes through the primary keyway.

In some embodiments, the primary keyway may include a curvilinear channel.

In some embodiments, the key is positioned in the primary keyway, the primary keyway prevents rotation of the filter cartridge, aligns the at least one displaceable latch feature with the at least one receptacle, and aligns the fluid inlet and outlet of the filter cartridge with a fluid connector of the manifold, and wherein the manifold is positioned in an appliance.

In some embodiments, an end portion of the primary keyway may include a sidewall configured to interact with the key to prevent rotation of the filter cartridge in the first direction, and wherein the end portion permits rotation of the filter cartridge in the second direction, after insertion of the filter cartridge into the manifold, a stop element of the at least one receptacle interacts with the at least one displaceable latch feature to prevent rotation of the filter cartridge in the first direction, and after insertion of the filter cartridge into the manifold, a curved transition surface of the manifold interacts with the at least one displaceable latch feature to permit rotation of the filter cartridge in the second direction.

In some embodiments, during insertion of the filter cartridge into the manifold, a latch feature of the at least one displaceable latch feature interacts with a curved interior surface of the manifold, prior to being received by the at least one receptacle to force the at least one displaceable latch feature to displace radially inward as a result.

In some embodiments, during removal of the filter cartridge from the manifold and counterclockwise rotation of the filter cartridge in the manifold, the at least one displaceable latch feature interacts with the curved transition surface of the at least one receptacle to force the at least one displaceable latch feature to displace radially inward, and the key rotates toward the entry end of the secondary keyway.

In another aspect, the present disclosure embraces a filter cartridge. The filter cartridge may include a filter body having a first end, a second end, and a longitudinal axis, a fluid inlet and outlet at the first end of the filter body, and an integrated locking head on the first end of the filter body, wherein the integrated locking head may include at least one displaceable latch feature extending longitudinally from the locking head, wherein the at least one displaceable latch feature is configured to be received by at least one receptacle on an inner surface of a manifold, and wherein the at least one receptacle may include a stop element at a first end of the at least one receptacle, and a curved transition surface at a second end of the at least one receptacle.

In some embodiments, the at least one displaceable latch feature may include a latch feature, wherein insertion of the filter cartridge into the manifold causes the at least displaceable latch feature to interact with a curved interior surface of the manifold, prior to being received by the at least one receptacle to force the at least one displaceable latch feature to displace radially inward as a result.

In some embodiments, after insertion of the filter cartridge into the manifold, the latch feature is structured to sit within the at least one receptacle and prevent movement of the filter cartridge in a direction along the longitudinal axis that is opposite an insertion direction.

In some embodiments, after insertion of the filter cartridge into the manifold, the at least one displaceable latch feature is structured to interact with the stop element of the at least one receptacle to prevent rotation of the filter cartridge in a first direction.

In some embodiments, after insertion of the filter cartridge into the manifold, the at least one displaceable latch feature is structured to interact with the curved transition surface of the at least one receptacle to permit rotation of the filter cartridge in a second direction.

In some embodiments, during removal of the filter cartridge from the manifold and during rotation of the filter cartridge in the second direction, the at least one displaceable latch feature interacts with the curved transition surface of the at least one receptacle to force the at least one displaceable latch feature to displace radially inward.

In some embodiments, the at least one displaceable latch feature is a first displaceable latch feature, wherein the integrated locking head may include a second displaceable latch feature, and wherein the first displaceable latch feature and the second displaceable latch feature are diametrically opposed relative an outer surface of the integrated locking head.

In some embodiments, the integrated locking head may include a key extending radially outward from the integrated locking head.

In some embodiments, during insertion of the filter cartridge into a manifold, the key is structured to pass through a primary keyway of an extraction guide of the manifold.

In some embodiments, when the key is positioned in a primary keyway of an extraction guide of a manifold, the primary keyway is structured to prevent rotation of the filter cartridge.

In some embodiments, the key has a cylinder shape and a radially-outward-facing surface that is sloped radially inward from a center of the radially-outward-facing surface.

In some embodiments, the at least one displaceable latch feature may include a first curved surface having a first radius, and wherein the at least one receptacle may include a second curved surface having a second radius at an interface surface receiving the first curved surface, wherein the second radius is smaller than the first radius.

In some embodiments, the at least one displaceable latch feature may include a first surface and the at least one receptacle may include a second surface, wherein in an installed configuration, the first surface and the second surface define an interface surface and at least one gap between the first surface and the second surface.

In another aspect, the present disclosure embraces a method. The method may include providing a filter cartridge having an integrated locking head, wherein the integrated locking head may include at least one displaceable latch feature, and wherein the at least one displaceable latch feature may include a latching mechanism, inserting, in an insertion direction, the filter cartridge into a manifold of an appliance, wherein the manifold may include at least one receptacle structured to receive the at least one displaceable latch feature, and while inserting, and prior to engaging the latching mechanism with the at least one receptacle, forcing the at least one displaceable latch feature to displace radially inward.

In some embodiments, the method may include while inserting, overcoming a force applied to the integrated locking head in an extraction direction opposite the insertion direction.

In some embodiments, the integrated locking head may include a key extending radially outward from the integrated locking head, the method may include, before inserting, aligning the key with a keyway of the manifold.

In some embodiments, the method may include, while the at least one displaceable latch feature is positioned in the at least one receptacle, preventing movement of the filter cartridge in an extraction direction opposite the insertion direction, and preventing, with a stop element of the at least one receptacle, rotation of the filter cartridge in a first direction.

In some embodiments, the method may include, while the at least one displaceable latch feature is positioned in the at least one receptacle, permitting, with a curved transition surface of the at least one receptacle, rotation of the filter cartridge in a second direction opposite the first direction.

In some embodiments, the method may include, after positioning the at least one displaceable latch feature in the at least one receptacle, rotating the filter cartridge in the second direction.

In some embodiments, the method may include, while rotating the filter cartridge in the second direction, forcing, with the curved transition surface of the at least one receptacle, the at least one displaceable latch feature to displace radially inward and disengage from a vertical surface of the at least one receptacle.

In some embodiments, the method may include, after forcing the at least one displaceable latch feature to displace radially inward and disengage from a vertical surface of the at least one receptacle, pushing the integrated locking head in an extraction direction opposite the insertion direction.

In some embodiments, the integrated locking head may include a key extending radially outward from the integrated locking head, the method may include, after forcing the at least one displaceable latch feature to displace radially inward and disengage from a vertical surface of the at least one receptacle, pulling the filter cartridge in an extraction direction opposite the insertion direction causing the key to enter a secondary keyway, of the manifold, that intersects with a primary keyway, of the manifold, through which the key passed while inserting the filter cartridge into the manifold.

In some embodiments, the method may include, while pulling the filter cartridge in the extraction direction, pulling the key through the secondary keyway and into the primary keyway.

In some embodiments, the method may include, while pulling the filter cartridge in the extraction direction, pulling the key through the primary keyway, and withdrawing the filter cartridge from the appliance.

In another aspect, the present disclosure embraces an adapter. The adapter may include a first portion structured to engage a filter cartridge, a second portion in fluid communication with the first portion, the second portion including at least one displaceable latch feature extending longitudinally from the second portion, wherein the at least one displaceable latch feature is configured to be received by at least one receptacle on an inner surface of a manifold, and wherein the at least one receptacle may include a stop element at a first end of the at least one receptacle, and a curved transition surface at a second end of the at least one receptacle.

In another aspect, the present disclosure embraces an adapter. The adapter may include a first portion structured to engage a filter cartridge, a second portion in fluid communication with the first portion, the second portion including a key extending radially outward from the second portion, and a channel on an outer surface of the second portion structured for receiving a latching mechanism of a manifold.

In another aspect, the present disclosure embraces a method. The method may include providing an adapter including a first portion and a second portion, the first portion structured to engage a filter cartridge, and the second portion in fluid communication with the first portion and including at least one displaceable latch feature, and wherein the at least one displaceable latch feature comprises a latching mechanism. The method may further include inserting, in an insertion direction, the adapter into a manifold of an appliance, wherein the manifold includes at least one receptacle structured to receive the at least one displaceable latch feature. The method may further include, while inserting, and prior to engaging the latching mechanism with the at least one receptacle, forcing the at least one displaceable latch feature to displace radially inward, and connecting the filter to the first portion of the adapter.

In another aspect, the present disclosure embraces a method. The method may include providing an adapter including a first portion and a second portion, the first portion structured to engage a filter cartridge, and the second portion in fluid communication with the first portion and including a key extending radially outward from the second portion, and a channel on an outer surface of the second portion structured for receiving a latching mechanism of a manifold of an appliance. The method may further include inserting, in an insertion direction, the adapter into the manifold, and connecting the filter to the first portion of the adapter.

In another aspect, the present disclosure embraces a method for securing a water filter. The method may include removing a first filter cartridge from a filter manifold of an appliance, wherein the appliance includes an extraction guide, attaching a retention device to the extraction guide, positioning a second filter cartridge within the filter manifold, and retaining the second filter cartridge using the retention device.

In some embodiments, the retention device may include a compression spring retaining device having a spring and a pin attached thereto.

In some embodiments, the retention device may include a compression spring retaining device having a spring, a pin attached to the spring, and a plate for receiving the pin.

In some embodiments, the retention device may include a leaf spring retaining device, and wherein the filter cartridge includes a relief portion for receiving the leaf spring.

In some embodiments, the retention device may include a rear retaining device having a rear retainer for retaining a cap of the filter cartridge.

In some embodiments, the retention device may include a circumferential retainer having a substantially arc shape and at least one finger extending inwardly.

In some embodiments, the retention device may include a circumferential retainer having a chamfer.

In some embodiments, the retention device may include a channel retainer assembly having a tab-like channel retainer, and wherein the filter cartridge includes a longitudinal groove for receiving the tab-like channel retainer.

In yet another aspect, the present disclosure embraces a filter cartridge. The filter cartridge may include a filter body having a first end, a second end, and a longitudinal axis, a fluid inlet and outlet at the first end of the filter body, and an integrated locking head on the first end of the filter body, wherein the integrated locking head includes at least one latching mechanism configured to be received by at least one receptacle on an inner surface of a manifold, wherein the at least one latching mechanism is selected from a group consisting of: a rotating prong, a rotatable prong, a prong rotating latching mechanism, and a retracting latching mechanism.

In some embodiments, the rotating prong is coupled to an axle via a spring.

In some embodiments, the rotatable prong is received within a prong mount of the integrated locking head, and wherein the prong mount includes an axle and a spring.

In some embodiments, the prong rotating latching mechanism is received within a prong mount of the integrated locking head, wherein the prong mount comprises a slot.

In some embodiments, the retracting latching mechanism includes a slot in a radial direction for receiving a latch.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made the accompanying drawings, wherein:

FIG. 1 illustrates a perspective view of a filter cartridge, in accordance with an embodiment of the disclosure;

FIG. 2 illustrates a close-up, side view of an integrated locking head of the filter cartridge, in accordance with an embodiment of the disclosure;

FIG. 3 illustrates another close-up, side view of the integrated locking head of the filter cartridge, in accordance with an embodiment of the disclosure;

FIG. 4 illustrates a close-up, side view of the filter cartridge and a portion of a manifold of an appliance, in accordance with an embodiment of the disclosure;

FIG. 5 illustrates a perspective view of a portion of the manifold, in accordance with an embodiment of the disclosure;

FIG. 6 illustrates a perspective view of the manifold with the filter cartridge inserted therein, in accordance with an embodiment of the disclosure;

FIG. 7 illustrates a perspective view of the manifold with the filter cartridge inserted therein with portions of the manifold removed, in accordance with an embodiment of the disclosure;

FIG. 8 illustrates another perspective view of the manifold with the filter cartridge inserted therein with portions of the manifold removed, in accordance with an embodiment of the disclosure;

FIG. 9 illustrates a side, cross-section view of the integrated locking head of the filter cartridge and latching mechanisms of the manifold after insertion of the filter cartridge into the manifold, in accordance with an embodiment of the disclosure;

FIG. 10 illustrates a side, cross-section view of the integrated locking head of the filter cartridge and the latching mechanisms of the manifold after partial rotation of the filter cartridge within the manifold, in accordance with an embodiment of the disclosure;

FIG. 11 illustrates a side, cross-section view of the integrated locking head of the filter cartridge and the latching mechanisms of the manifold after further rotation of the filter cartridge within the manifold, in accordance with an embodiment of the disclosure;

FIG. 12 illustrates a perspective view of the filter cartridge and the manifold with portions of the manifold removed after rotation of the filter cartridge within the manifold, in accordance with an embodiment of the disclosure;

FIG. 13 illustrates a perspective view of the filter cartridge and the manifold with portions of the manifold removed during removal of the filter cartridge, in accordance with an embodiment of the disclosure;

FIG. 14 illustrates a perspective view of a filter cartridge, in accordance with an embodiment of the disclosure;

FIG. 15A illustrates a close-up, side view of an integrated locking head of the filter cartridge, in accordance with the embodiment of FIG. 14;

FIG. 15B illustrates a perspective view of a flexible prong of an integrated locking head of a filter cartridge, in accordance with an embodiment of the disclosure;

FIGS. 15C-15E illustrate side views of an integrated locking head of a filter cartridge, in accordance with embodiments of the disclosure;

FIG. 15F illustrates a cutaway view of a flexible prong received by a receptacle of a manifold, in accordance with the embodiment of FIG. 15B;

FIGS. 15G-15I illustrate perspective views of a flexible prong received by a receptacle of a manifold, in accordance with the embodiment of FIG. 15B;

FIG. 16 illustrates another close-up, side view of the integrated locking head of the filter cartridge, in accordance with the embodiment of FIG. 14;

FIG. 17 illustrates a perspective view of an integrated locking head, in accordance with the embodiment of FIG. 14;

FIG. 18 illustrates a front view of an integrated locking head attached to a portion of a manifold, in accordance with the embodiment of FIG. 14;

FIG. 19 illustrates a close-up, side view of the filter cartridge and a portion of a manifold of an appliance, in accordance with the embodiment of FIG. 14;

FIG. 20 illustrates a perspective view of the manifold with the filter cartridge inserted therein, in accordance with the embodiment of FIG. 14;

FIG. 21 illustrates a perspective view of the manifold with the filter cartridge inserted therein with portions of the manifold removed, in accordance with the embodiment of FIG. 14;

FIG. 22 illustrates a front, cross-section view of the integrated locking head of the filter cartridge and displaceable latch features of the manifold after insertion of the filter cartridge into the manifold, in accordance with the embodiment of FIG. 14;

FIG. 23 illustrates a front, cross-section view of the integrated locking head of the filter cartridge in the context of insertion procedure, wherein the displaceable latch features are currently disengaged from the receptacles, in accordance with the embodiment of FIG. 14;

FIG. 24 illustrates a front, cross-section view of the integrated locking head of the filter cartridge and the displaceable latch features of the manifold after rotation of the filter cartridge within the manifold during the removal process, in accordance with the embodiment of FIG. 14;

FIG. 25 illustrates a perspective view of an integrated locking head of a filter cartridge, in accordance with an embodiment of the disclosure;

FIGS. 26A and 26B illustrate perspective views of a rotatable prong, in accordance with an embodiment of the disclosure;

FIGS. 27A and 27B illustrate perspective views of a prong rotating latching mechanism, in accordance with an embodiment of the disclosure;

FIG. 28 illustrates a perspective view of a retracting latching mechanism, in accordance with an embodiment of the disclosure;

FIG. 29 illustrates a side, cross-section view of a compression spring retaining device, in accordance with an embodiment of the disclosure;

FIG. 30 illustrates a side, cross-section view of a compression spring retaining device, in accordance with an embodiment of the disclosure;

FIG. 31 illustrates a perspective view of a leaf spring retaining device, in accordance with an embodiment of the disclosure;

FIG. 32 illustrates a side, cross-section view of a rear retaining device, in accordance with an embodiment of the disclosure;

FIGS. 33A and 33B illustrate perspective views of a circumferential retainer, in accordance with an embodiment of the disclosure;

FIGS. 34A-34C illustrate perspective views of a circumferential retainer, in accordance with an embodiment of the disclosure;

FIGS. 35A-35C illustrate perspective views of a channel retainer, in accordance with an embodiment of the disclosure;

FIGS. 36A-36B illustrate perspective views and a partial cutaway view of an extraction guide, in accordance with an embodiment of the disclosure;

FIG. 37 illustrates a perspective view of a hinged tab filter cartridge integrated locking head, in accordance with an embodiment of the disclosure;

FIG. 38A illustrates a top, rear, left side perspective view of an extraction guide, in accordance with an embodiment of the disclosure;

FIG. 38B illustrates a bottom, rear, left side perspective view of an extraction guide, in accordance with an embodiment of the disclosure;

FIGS. 39A-39C illustrate an adapter with fluid inlet and outlet features structured to be received by the fluid inlet and outlet of the manifold, in accordance with an embodiment of the disclosure;

FIGS. 40A-40C illustrate an adapter with fluid inlet and outlet features structured to be received by the fluid inlet and outlet of the manifold, in accordance with an embodiment of the disclosure;

FIGS. 41A-41C illustrate an adapter with fluid inlet and outlet features structured to be received by an integrated locking head and allow for the use of another water filter, in accordance with an embodiment of the disclosure; and

FIGS. 42A-42C illustrate an adapter for a filter media structured to be received by an integrated locking head and allow for the use of another filter media, in accordance with an embodiment of the disclosure.

### DETAILED DESCRIPTION OF EMBODIMENTS OF THE DISCLOSURE

Embodiments of the present disclosure will now be described more fully hereinafter with reference to the accompanying drawings, in which some, but not all, embodiments of the disclosure are shown. Indeed, the disclosure may be implemented in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

As used herein, “operatively coupled” may mean that the components may be formed integrally with each other or may be formed separately and coupled together. Furthermore, “operatively coupled” may mean that the components may be formed directly to each other or to each other with one or more components located between the components that are operatively coupled together. Additionally, or alternatively, “operatively coupled” may mean that the components are detachable from each other or that they are permanently coupled together. Furthermore, “operatively coupled” components may mean that the components retain at least some freedom of movement in one or more directions or may be rotated about an axis (i.e., rotationally coupled, pivotally coupled, and/or the like).

As noted, appliances, such as food refrigeration appliances, cooking appliances, fabric care appliances, and/or the like, may include one or more components, such as a water dispenser, an ice maker, a steam generator, or a water inlet and/or the like, which use water from a water supply (e.g., a household water supply and/or the like). Such appliances typically include a water filter that filters water received from the water supply before the water is provided to the one or more components. Such water filters have a useful lifespan that may be shorter than the appliance and must be replaced for the appliance to continue to provide properly filtered water. Appliances typically include an opening to permit a user to remove an expired water filter and install a replacement water filter. However, the user may have difficulty determining the correct steps to remove the expired water filter. Furthermore, the user may have difficulty installing the replacement water filter due to a failure to properly align the replacement water filter with a manifold within the appliance, due to a lack of indication that the replacement water filter has been properly installed, and/or the like.

Some embodiments described herein provide a mechanical interlock system for a filter, such as a water filter, which may be included in an appliance. In some embodiments, the mechanical interlock system may include a filter cartridge and a manifold (e.g., a filter cartridge manifold) for an appliance push-to-lock mechanism for securing the filter cartridge and a twist-to-unlock mechanism for releasing the filter cartridge. The filter cartridge may have an integrated locking head, which may include a key extending radially outward from the integrated locking head and one or more channels on an outer surface of the integrated locking head. The mechanical interlock system may include a manifold for receiving the filter cartridge, where the manifold includes an extraction guide and one or more latching mechanisms (e.g., claws). In some embodiments, the key of the integrated locking head may interact with the extraction guide to properly align the filter cartridge during installation of the filter cartridge and removal of the filter cartridge. Additionally, or alternatively, the one or more latching mechanisms may interact with the one or more channels on the integrated locking head to permit insertion of the filter cartridge, provide an indication that the filter cartridge has been properly installed, prevent rotation of the filter cartridge in an incorrect direction, and permit rotation of the filter cartridge in a correct direction. In some embodiments, the mechanical interlock system may include a stop element to prevent over-rotation of the filter cartridge in the correct direction.

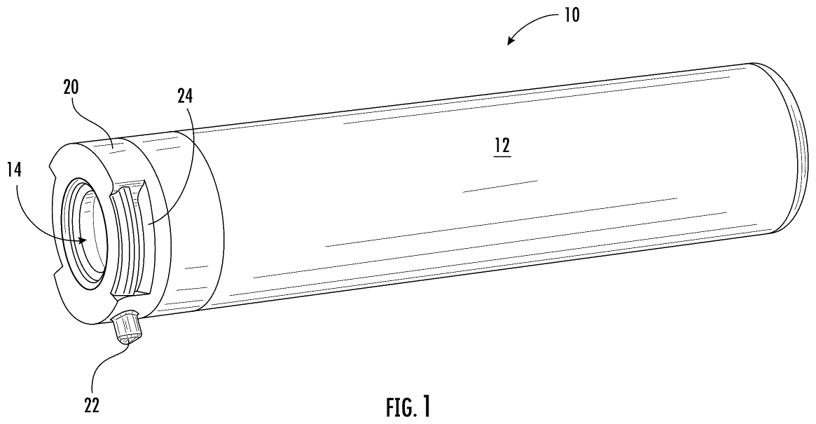

FIG. 1 illustrates a perspective view of a filter cartridge 10, in accordance with an embodiment of the disclosure. As shown in FIG. 1, the filter cartridge 10 may include a filter body 12, also referred to as a filter housing, which typically encloses a fluid filtration material. The filter body 12 may be substantially cylindrical and may define a first end and a second end along a longitudinal axis. Additionally, or alternatively, the filter body 12 may be slightly conical such that the first end has a smaller radius than the radius of the second end.

The filter cartridge 10 may include a fluid inlet and outlet 14 as well as an integrated locking head 20, which may be formed into the filter body 12 and/or attached to the filter body 12 as shown in FIG. 1. In some embodiments, the fluid inlet and outlet 14 may be formed in a central portion of the first end of the filter body 12, and the integrated locking head may be formed into the filter body 12 and/or attached to the filter body 12 at a peripheral portion of the first end of the filter body 12. In use, water may pass through the fluid inlet into the filter body 12, be filtered by the fluid filtration material, and pass through the fluid outlet to the appliance.

As shown in FIG. 1, the integrated locking head 20 may include a key 22 and a channel 24. In some embodiments, the key 22 may extend radially outward from the integrated locking head 20 (e.g., from an outer surface of the integrated locking head 20 and/or the like). Although not shown in FIG. 1, the integrated locking head 20 may include another channel positioned on the opposite side of the integrated locking head 20 from the channel 24. In some embodiments, the channels 24 may be positioned and/or formed on an outer surface of the integrated locking head 20. Additionally, or alternatively, the channels 24 may be diametrically opposed on the outer surface of the integrated locking head. In some embodiments, and as described herein, the channels 24 may be structured and/or configured for receiving latching mechanisms, preventing rotation of the filter cartridge 10 in a first direction, and permitting rotation of the filter cartridge 10 in a second direction.

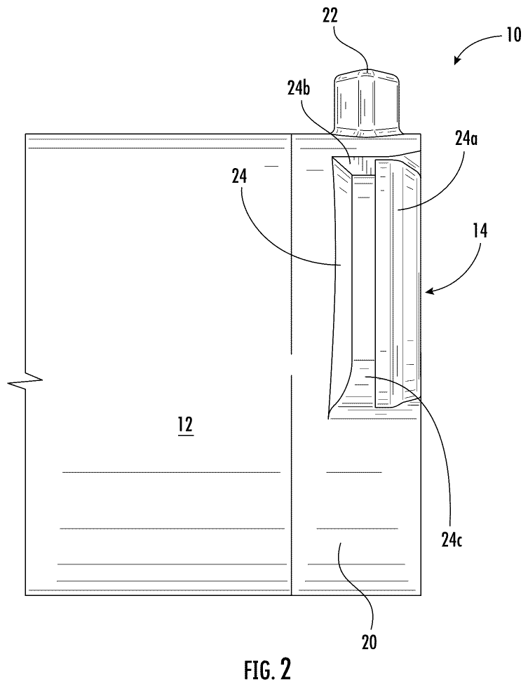

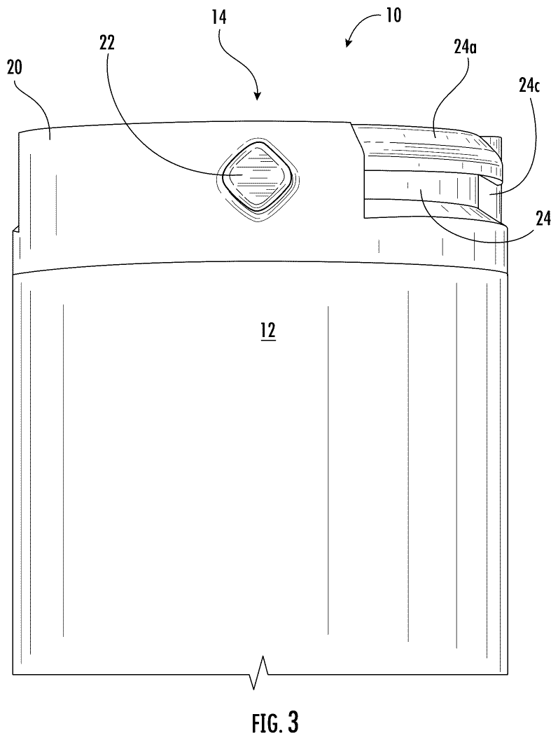

FIG. 2 illustrates a close-up, side view of the integrated locking head 20 of the filter cartridge 10. FIG. 3 illustrates another close-up, side view of the integrated locking head 20 of the filter cartridge 10. As shown in FIG. 2, the channel 24 may include a chamfered edge 24a oriented towards the fluid inlet and outlet 14, a vertical sidewall 24b on a first end of the channel 24, and a filleted or curved sidewall 24c on a second end of the channel 24. As described further herein, the chamfered edge 24a, the vertical sidewall 24b, and the filleted sidewall 24c may interact with corresponding features on a lock mechanism on a manifold 40 (e.g., a filter cartridge manifold). As shown in FIG. 3, the key 22 may be shaped as an extruded rhombus with a tip that may be sloped from its center, and, as described further herein, the key 22 may interact with keyways in a tube of the manifold 40. In some embodiments, the key 22 may have a rhomboid-shape and a radially-outward-facing surface that may be sloped radially inward from a center of the radially-outward-facing surface.

In other embodiments, the key 22 may be substantially circular or oval in cross sectional shape, star-shaped, hexagonal, triangular, or any other combination of polygonal and/or curved shape.

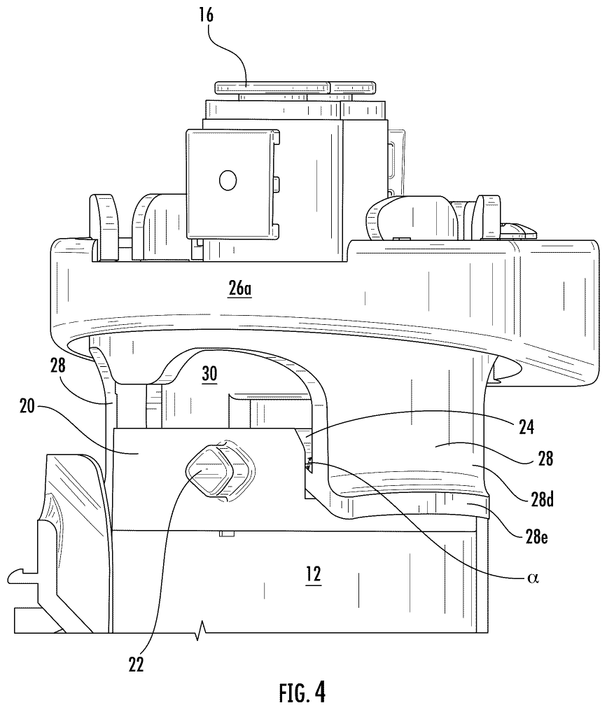

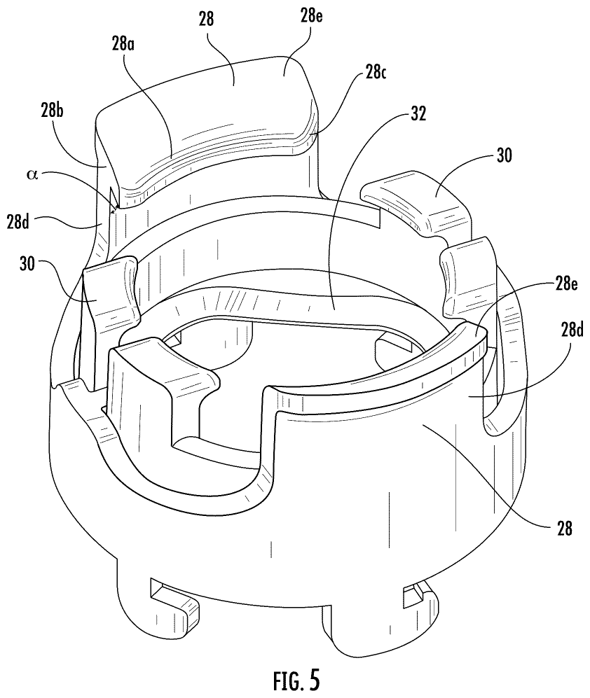

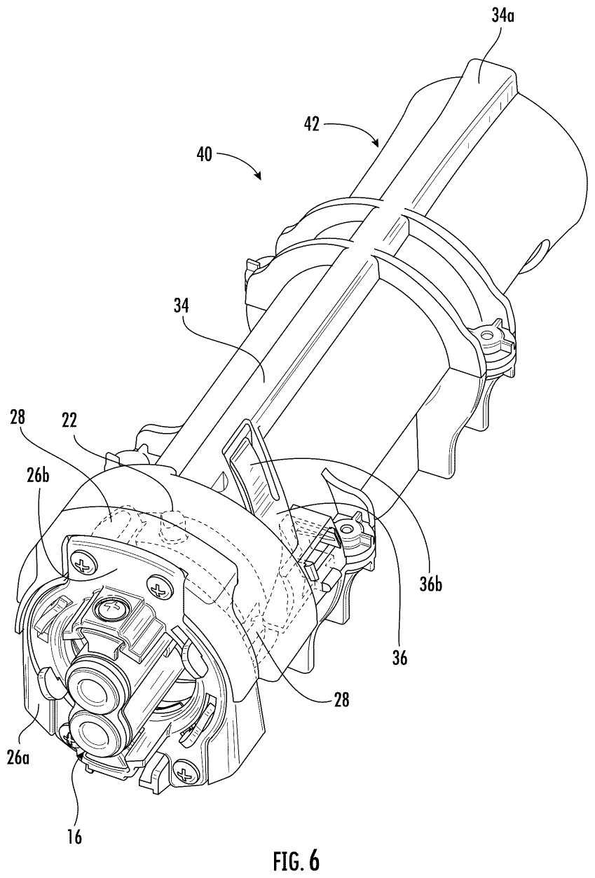

FIG. 4 illustrates a close-up, side view of the filter cartridge and a portion of a manifold 40 of an appliance. FIG. 5 illustrates a perspective view of a portion of the manifold 40. As shown in FIG. 4, the manifold 40 may include a first base component 26a, a locking mechanism including two latching mechanisms 28, and a fluid connector 16. In some embodiments, the first base component 26a may be connected to the locking mechanism and/or the latching mechanisms 28. Additionally, or alternatively, the first base component 26a may be connected to the appliance (e.g., via fasteners and/or the like) and/or may be connected to a second base component 26b (See FIG. 6), which may be connected to the appliance. The first base component 26a and/or the second base component 26b may maintain positioning of the locking mechanism including the latching mechanisms 28 within the appliance, with respect to the manifold 40, and with respect to the fluid connector 16 in the appliance. The fluid connector 16 of the manifold 40 provides a fluid connection between the internal components of the appliance and the fluid inlet and outlet 14 of the filter cartridge 10.

As shown in FIGS. 4 and 5, the manifold 40 may also include a pusher component 30 that may be spring-loaded by a spring element 32 (See FIG. 5). In some embodiments, the spring element 32 may be positioned between the pusher component 30 and the first base component 26a and/or the second base component 26b. Additionally, or alternatively, during installation of the filter cartridge 10, the pusher component 30 may provide a compressive force against the integrated locking head 20 that assists with seating the two latching mechanisms 28 in the corresponding channels 24 on opposite sides of the integrated locking head 20 (See FIG. 4).

As shown in FIG. 5, the latching mechanisms 28 may include a chamfered inner edge 28a, a vertical sidewall 28b, and a filleted or curved sidewall 28c. The chamfered inner edge 28a may interact with the chamfered edge 24a of the integrated locking head 20 shown in FIGS. 2 and 3 such that, as the filter cartridge 10 is inserted into the manifold 40, the latching mechanisms 28 displace (e.g., flex, rotate, and/or the like) radially outward allowing the integrated locking head 20 to insert into the manifold 40 and/or the fluid inlet and outlet 14 to connect to a corresponding fluid connector 16 on the appliance. After the chamfered inner edges 28a pass into the channels 24 of the locking head 20, the latching mechanisms 28 may sit within the channels 24 (See FIG. 4) and lock the filter cartridge 10 within the manifold 40 by preventing movement in a direction along the longitudinal axis that is opposite the insertion direction. The seating of the latching mechanisms 28 within the channels 24 may generate a noise indicating that the filter cartridge 10 may be locked in the manifold 40.

As shown in FIGS. 4 and 5, the latching mechanisms 28 may include a neck portion 28d extending parallel to the longitudinal axis in a direction opposite the insertion direction and a head portion 28e at an end of the neck portion 28d. In some embodiments, the head portion 28e may have a curvature complementary to an outer curvature of the integrated locking head 20. Additionally, or alternatively, the head portion 28e may be angled inward from an outer edge to an inner edge, which may guide the integrated locking head 20 into a space between the latching mechanisms 28 during insertion.

In some embodiments, and as shown in FIGS. 4 and 5, the outer edge of the head portion may extend radially outward beyond the neck portion 28d, which may improve an ability of the latching mechanisms 28 to guide the integrated locking head 20 into a space between the latching mechanisms 28 during insertion. Additionally, or alternatively, and as also shown in FIGS. 4 5, the inner edge of the head portion 28e may extend radially inward from the neck portion 28d, which may permit the latching mechanisms 28 to sit in the channels 24 and prevent movement of the filter cartridge 10 in a direction opposite the insertion direction. In some embodiments, and as also shown in FIGS. 4 and 5, an angle a between the inner edge of the head portion and the neck portion may be less than 90 degrees, which may improve an ability of the latching mechanisms 28 to prevent movement of the filter cartridge 10 in a direction opposite the insertion direction. In some embodiments, and as described herein, the latching mechanisms 28 may be structured and/or configured to prevent, after being received by the channels 24, movement of the filter cartridge 10 in a direction along the longitudinal axis that is opposite an insertion direction, prevent rotation of the filter cartridge 10 in a first direction, and permit rotation of the filter cartridge 10 in a second direction.

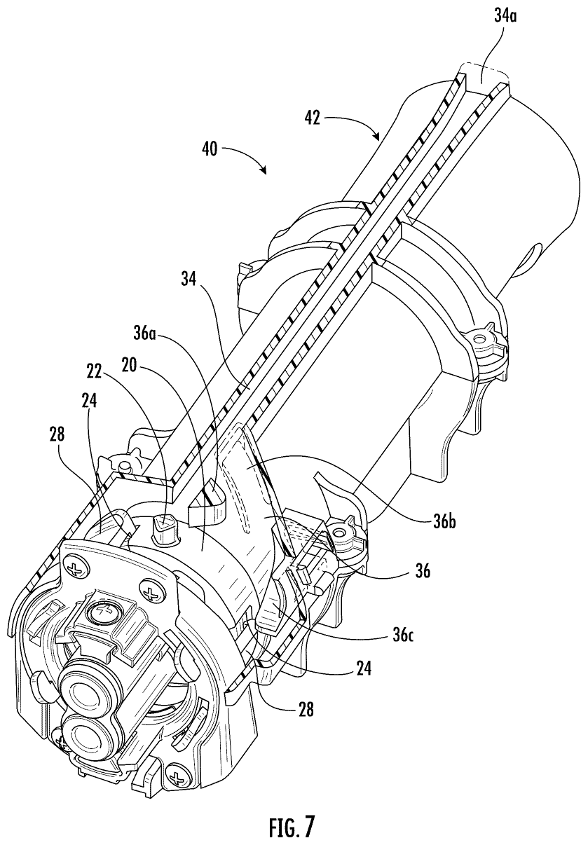

FIG. 6 illustrates a perspective view of the manifold 40 with the filter cartridge inserted therein. FIG. 7 illustrates a perspective view of the manifold with the filter cartridge inserted therein with portions of the manifold 40 removed. As shown in FIGS. 6 and 7, the manifold 40 may include an insertion and extraction tube 42 having two keyways 34 and 36 (e.g., a primary keyway 34 and a secondary keyway 36) that intersect. In some embodiments, keyway 34 may be straight and extend parallel to the longitudinal axis of the filter cartridge 10. When a user inserts the filter cartridge 10, the key 22 on the integrated locking head 20 may pass through keyway 34, and keyway 34 may prevent rotation of the filter cartridge 10 during insertion.

In some embodiments, when the key 22 is positioned in the keyway 34, the keyway 34 prevents rotation of the filter cartridge 10, aligns one of the two latching mechanisms 28 with one of the two channels 24 and another of the two latching mechanisms 28 with another of the two channels 24, and aligns the fluid inlet and outlet 14 of the filter cartridge 10 with the fluid connector 16 of an appliance. In some embodiments, and as shown in FIGS. 6 and 7, the insertion and extraction tube 42 may include an insertion end 34a for receiving and guiding the key 22 into the keyway 34, where the insertion end 34a may be wider than the keyway 34, which may improve the ability of a user to insert the key 22 into the keyway 34 and the filter cartridge 10 into the appliance.

As shown in FIGS. 6 and 7, keyway 36 may be curved and may include a wedge element 36a and a leaf spring element 36b. The wedge element 36a may be configured to guide the key 22 into the keyway 36 after the pusher component 30 pushes the filter cartridge 10. In some embodiments, keyway 36 may have an entry end and an exit end, where the exit end of keyway 36 connects to keyway 34. The leaf spring element 36b, as shown in FIG. 6, may be biased downward to prevent the key 22 from entering keyway 36 during insertion and to displace (e.g., flex, rotate, and/or the like) upward to permit the key 22 to exit keyway 36 and enter keyway 34 during extraction of the filter cartridge 10. Although the leaf spring element 36b shown in FIG. 6 may be biased downward into keyway 36, the leaf spring element 36b may be biased into the keyway 36 from another direction (e.g., from a side of keyway 36 and/or the like). The curved shape of keyway 36 may reduce any inertia the filter cartridge 10 may have during extraction (e.g., due to being pushed by the pusher component 30).

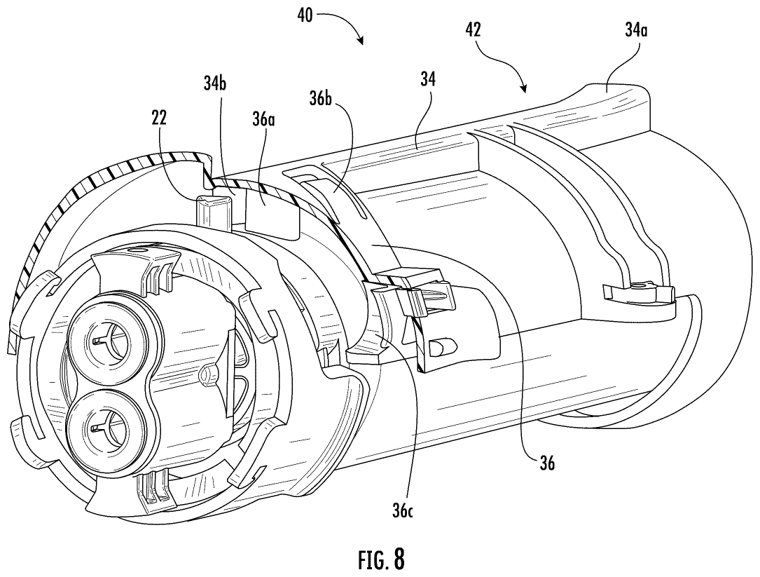

FIG. 8 illustrates another perspective view of the manifold 40 with the filter cartridge inserted therein with portions of the manifold 40 removed. As shown in FIG. 8, the end portion of keyway 34 may include an end portion with a sidewall 34b and/or the like that interacts with the key 22 to prevent clockwise rotation (e.g., from a user's perspective) of the filter cartridge 10 but permits counterclockwise rotation of the key 22 and the filter cartridge 10. As also shown in FIG. 8, the manifold 40 may include a stop element 36c that interacts with the key 22 to prevent over-rotation of the filter cartridge 10 in a counterclockwise direction. In some embodiments, the stop element 36c have a curved surface to guide the key 22 into keyway 36.

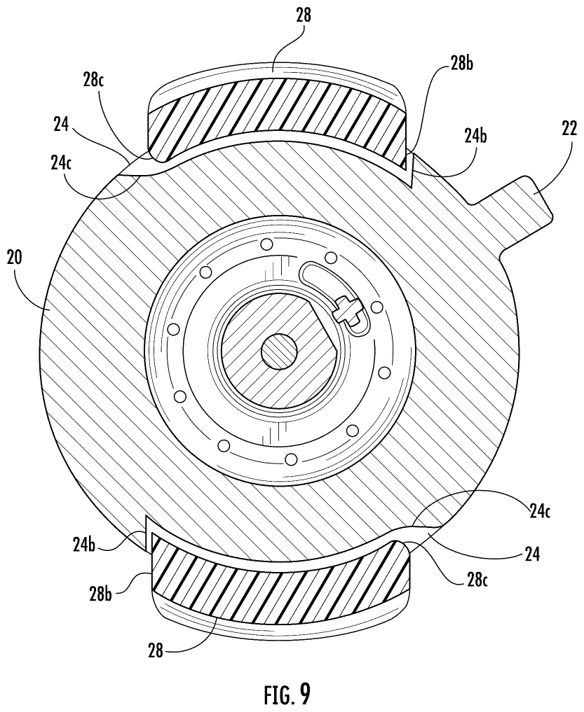

FIG. 9 illustrates a side, cross-section view of the integrated locking head 20 of the filter cartridge and latching mechanisms 28 of the manifold 40 after insertion of the filter cartridge into the manifold 40. As shown in FIG. 9, the inner radius of the latching mechanisms 28 may be less than the outer radius of the integrated locking head 20, such that the latching mechanisms 28, when seated in the channels 24, prevent movement of the filter cartridge 10 in a direction opposite the insertion direction. As also shown in FIG. 9, the vertical sidewalls 28b of the latching mechanisms 28 may interact with the vertical sidewalls 24b of the channels 24 in the integrated locking head 20 to prevent clockwise rotation (e.g., from a user's perspective) of the filter cartridge 10.

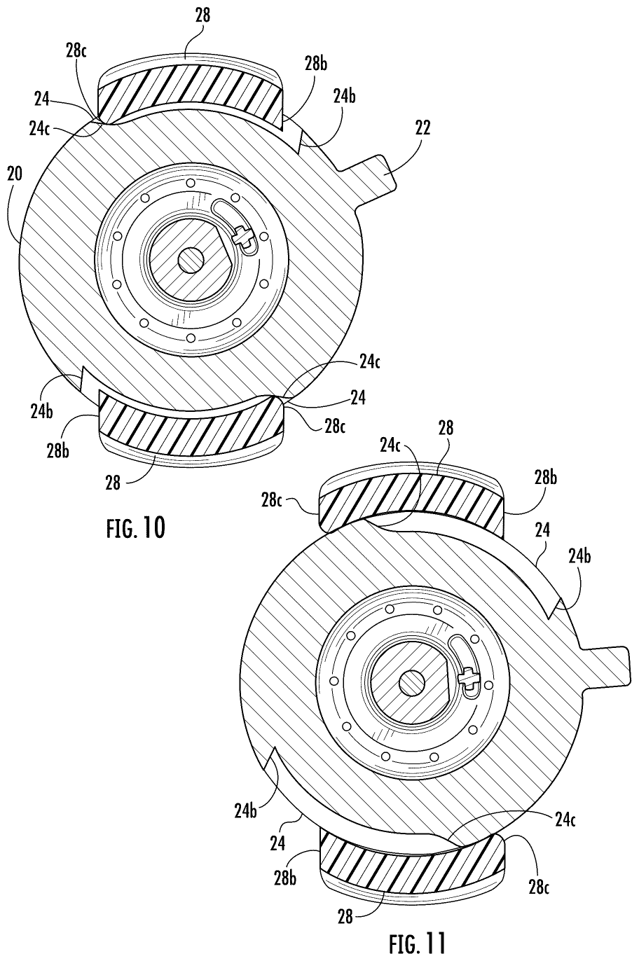

FIG. 10 illustrates a side, cross-section view of the integrated locking head 20 of the filter cartridge and the latching mechanisms 28 of the manifold 40 after partial rotation of the filter cartridge within the manifold 40. As shown in FIG. 10, the filleted sidewalls 28c may interact with the filleted sidewalls 24c of the channels 24 to permit counterclockwise rotation (e.g., from the user's perspective) of the filter cartridge 10.

FIG. 11 illustrates a side, cross-section view of the integrated locking head 20 of the filter cartridge and the latching mechanisms 28 of the manifold 40 after further rotation of the filter cartridge within the manifold 40. As shown in FIG. 10, the filleted sidewalls 28c may interact with the filleted sidewalls 24c of the channels 24 to force, after sufficient counterclockwise rotation (e.g., from the user's perspective) of the filter cartridge 10, the two latching mechanisms 28 to displace (e.g., flex, rotate, and/or the like) radially outward and slide over the outer circumference of the integrated locking head 20, thereby unlocking the integrated locking head 20 from the manifold 40.

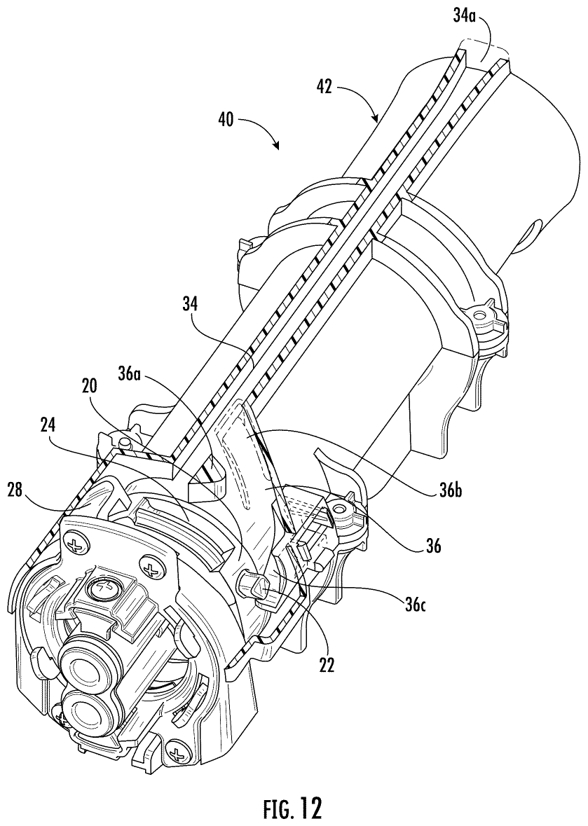

FIG. 12 illustrates a perspective view of the filter cartridge and the manifold 40 with portions of the manifold 40 removed after rotation of the filter cartridge within the manifold 40. As shown in FIG. 12, after a user rotates the filter cartridge in a counterclockwise direction, from the user's perspective, the latching mechanisms 28 may slide out of the channels 24 (e.g., due to the filleted sidewalls 28c of the latching mechanisms 28 and the filleted sidewalls 24c of the channels 24 as described with respect to FIGS. 9-11), displace (e.g., flex, rotate, and/or the like) radially outward, and slide over the outer circumference of the integrated locking head 20. Furthermore, and as shown in FIG. 12, after the user rotates the filter cartridge in the counterclockwise direction, the key 22 rotates towards the stop element 36c. As the filter cartridge becomes unlocked from manifold 40 due to the latching mechanisms 28 sliding out of the channels 24, the pusher component 30, which may be spring-loaded by the spring element 32 (See FIG. 5), may push the filter cartridge 10 in a direction opposite the insertion direction causing the key 22 to enter keyway 36. As described herein, the wedge element 36a and/or the stop element 36c may guide the key 22 into keyway 36. Furthermore, as the user pulls the filter cartridge in a direction opposite the insertion direction, the key 22 may pass through keyway 36, and the leaf spring element 36b may displace (e.g., flex, rotate, and/or the like) to permit the key 22 to pass through keyway 36.

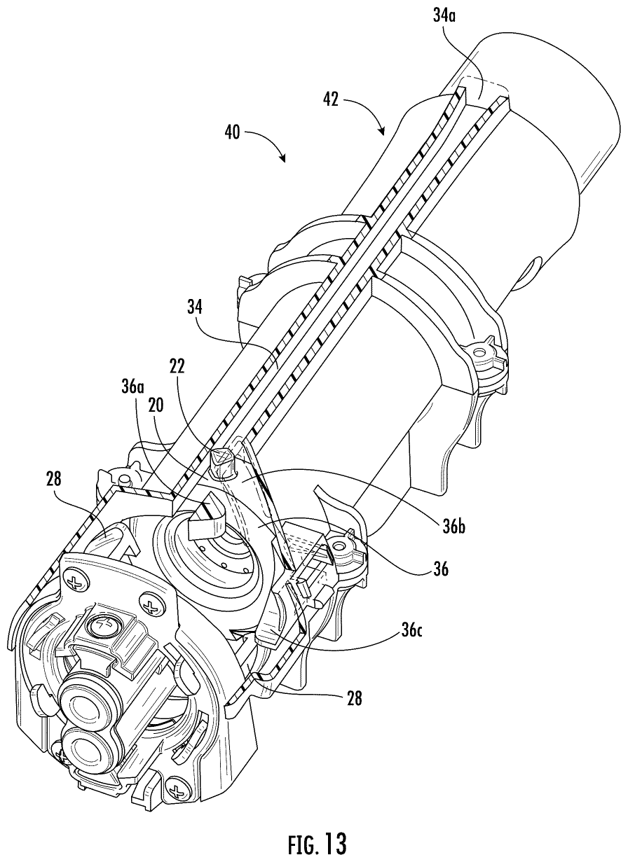

FIG. 13 illustrates a perspective view of the filter cartridge and the manifold 40 with portions of the manifold 40 removed during removal of the filter cartridge. As shown in FIG. 13, as the user pulls the filter cartridge in a direction opposite the insertion direction, the key 22 may exit keyway 36 and enter keyway 34. The user may continue to pull the filter cartridge, and the key 22 may pass through keyway 34 toward the insertion end 34a until the filter cartridge may be completely removed from the manifold 40 and/or the appliance.

In some embodiments, the present disclosure embraces a method of inserting a filter cartridge into a filter manifold and/or removing a filter cartridge from a manifold 40. First, the method may include aligning the key 22 (FIGS. 1-3) with the insertion end 34a of keyway 34 of the insertion and extraction tube 42 (FIGS. 6-8) and inserting, in an insertion direction, the filter cartridge 10 into the manifold 40 such that the key 22 passes through keyway 34. While inserting the filter cartridge 10 in the insertion direction, the leaf spring element 36b (FIGS. 6-8) typically prevents the key 22 from entering keyway 36. Next, the method may include engaging the integrated locking head 20 with the latching mechanisms 28 (FIGS. 4-5) and forcing the latching mechanisms 28 to displace (e.g., flex, rotate, and/or the like) radially outward. The method may also include engaging the integrated locking head 20 with the pusher component 30 (FIGS. 4-5) and overcoming a force applied by the pusher component 30 to the integrated locking head 20 in a direction opposite the insertion direction. The method may further include, after forcing the latching mechanisms 28 to displace (e.g., flex, rotate, and/or the like) radially outward, positioning the latching mechanisms 28 in the channels 24 (FIGS. 4 and 7-9). The method may also include applying a force, with the pusher component 30, to the integrated locking head 20 in a direction opposite the insertion direction after the latching mechanisms 28 are positioned in the channels 24 and preventing movement of the filter cartridge 10 in the direction opposite the insertion direction. In some embodiments, the method may include, after the latching mechanisms 28 are positioned in the channels 24, preventing, with the vertical sidewalls 24b of the channels 24 (FIGS. 2 and 9-11) and the vertical sidewalls 28b of the latching mechanisms 28 (FIGS. 5 and 9-11), rotation of the filter cartridge 10 in a first direction (e.g., a clockwise direction).

As noted, the present disclosure may embrace a method of removing a filter cartridge from a manifold 40. The method may include, after the latching mechanisms 28 are positioned in the channels 24, permitting, with the filleted sidewalls 24c of the channels 24 (FIGS. 2 and 9-11) and the filleted sidewalls 28c of the latching mechanisms 28 (FIGS. 5 and 9-11), rotation of the filter cartridge 10 in a second direction opposite the first direction (e.g., a counterclockwise direction). The method may include, after the latching mechanisms 28 are positioned in the channels 24, rotating the filter cartridge 10 in the second direction and forcing, with the filleted sidewalls 24c of the channels 24 and the filleted sidewalls 28c of the latching mechanisms 28, the latching mechanisms 28 to displace (e.g., flex, rotate, and/or the like) radially outward and engage the outer surface of the integrated locking head 20 (FIGS. 11-12).

In some embodiments, the method may include, after forcing the latching mechanisms 28 to displace (e.g., flex, rotate, and/or the like) radially outward and engage the outer surface of the integrated locking head 20, pushing, with the pusher component 30, the integrated locking head 20 and the filter cartridge 10 in an extraction direction opposite the insertion direction, such that the key 22 enters keyway 36. The method may include preventing over-rotation of the filter cartridge 10 with the stop element 36c (FIG. 12). Additionally, or alternatively, the method may include guiding the key 22 into keyway 36 with the wedge element 36a (FIGS. 7-8 and 12-13). The method may also include pulling the filter cartridge 10 in the extraction direction such that the key 22 passes through keyway 36, pushes the leaf spring element 36b upward, and enters keyway 34 (FIG. 13). The method may also include, while pulling the filter cartridge 10 in the extraction direction and while the key 22 passes through keyway 36, rotating the filter cartridge 10 in the first direction (e.g., a clockwise direction). The method may further include pulling the filter cartridge 10 in the extraction direction such that the key 22 passes through keyway 34 and the insertion end 34a and withdrawing the filter cartridge 10.

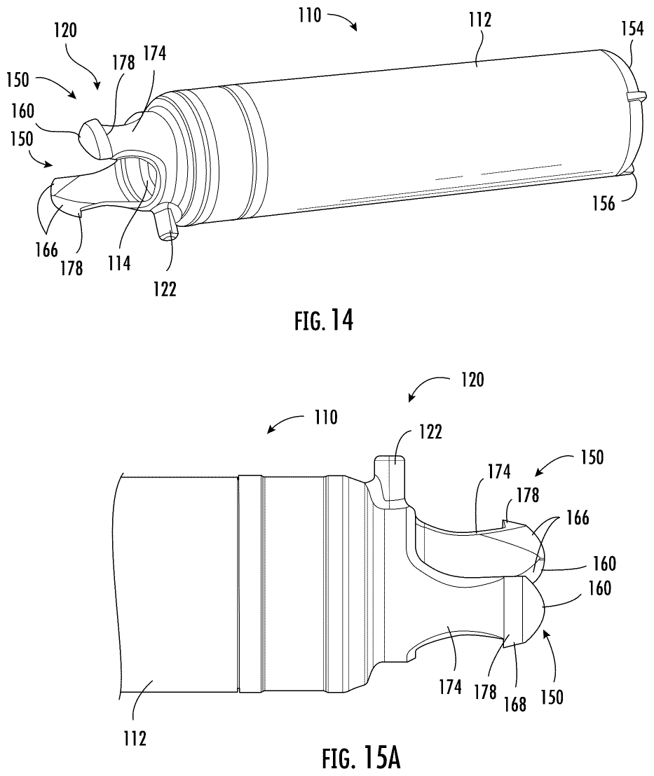

FIG. 14 illustrates a perspective view of a filter cartridge 110, in accordance with an embodiment of the disclosure. It shall be appreciated that the latching mechanism 28 of the embodiment described with respect to FIGS. 1-13 may be included as a portion of the manifold 40, while the channel 24 receiving the latching mechanism 28 may be included as a portion of the integrated locking head 20. However, as will be described hereinafter, in other embodiments the latching mechanism (e.g., the displaceable latch feature, referred to as flexible prongs 150 in FIG. 14) may be included as a portion of the integrated locking head 120. Accordingly, the corresponding channel (i.e., receptacles 158) for receiving the latching mechanism may be included as a portion of the manifold 140.

As shown in FIG. 14, the filter cartridge 110 may include a filter body 112, also referred to as a filter housing, which typically encloses a fluid filtration material. The filter body 112 may be substantially cylindrical and may define a first end and a second end along a longitudinal axis. Additionally, or alternatively, the filter body 112 may be slightly conical such that the first end has a smaller radius than the radius of the second end.

The filter cartridge 110 may include a fluid inlet and outlet 114 as well as an integrated locking head 120, which may be formed into the filter body 112 and/or attached to the filter body 112 as shown in FIG. 14. In some embodiments, the fluid inlet and outlet 114 may be formed in a central portion of the first end of the filter body 112, and the integrated locking head 120 may be formed into the filter body 112 and/or attached to the filter body 112 at a peripheral portion of the first end of the filter body 112. In use, water may pass through the fluid inlet into the filter body 112, be filtered by the fluid filtration media, and pass through the fluid outlet to the appliance. In some embodiments, the fluid inlet and outlet 114 may be similar to fluid inlet and outlet 14, as previously shown and described with respect to FIGS. 5-6.

As shown in FIG. 14, the integrated locking head 120 may include a key 122 and two displaceable latch features, depicted in FIG. 14 as flexible prongs 150. The displaceable latch features may, in some embodiments, have different features as compared to the flexible prongs 150 (e.g., rotating elements, latches, blocks, and/or the like). In some embodiments, the key 122 may extend radially outward from the integrated locking head 120 (e.g., from an outer surface of the integrated locking head 120 and/or the like). In some embodiments, the key 122 may be similar to key 22, as previously shown and described with respect to FIG. 2. In some embodiments, the flexible prongs 150 may extend from the integrated locking head 120 in a substantially longitudinal direction. Accordingly, in some embodiments, the flexible prongs 150 may define a fixed end and a free end, and extend in a substantially longitudinal direction therebetween. In some embodiments, the fixed end of the flexible prongs 150 may be positioned on a peripheral outer surface of the integrated locking head 120. In other embodiments, the fixed end of the flexible prongs 150 may be positioned on a top surface of the integrated locking head 120. In some embodiments, the flexible prongs 150 may be diametrically opposed relative the outer surface of the integrated locking head 120.

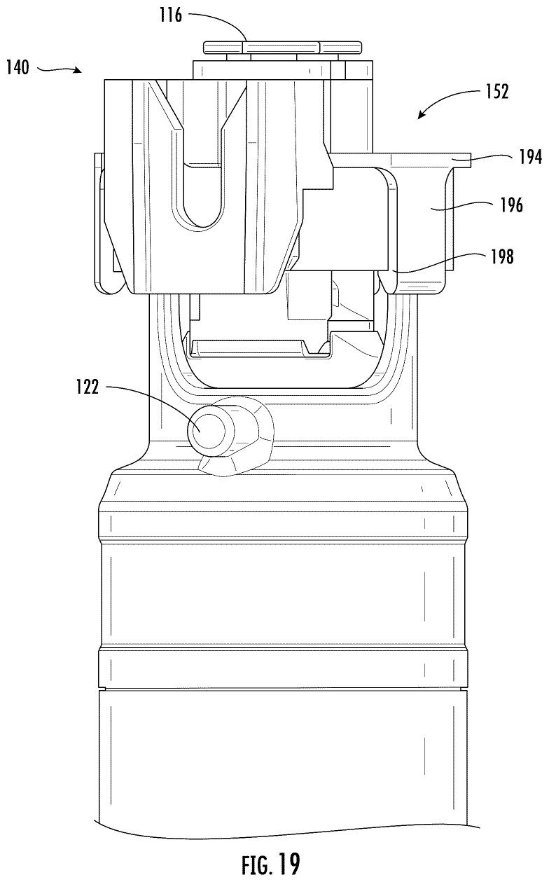

In some embodiments, a latch surface of the flexible prongs 150 may be able to engage a sidewall of the channel of a corresponding manifold 140 (e.g., the receptacles 158 of the manifold 140, as will be described with respect to FIGS. 19-24) in a latched condition, and to be disengaged from the sidewall of the channel (e.g., the receptacles 158) in a different position to allow the displaceable latch features to be removed from the receiver portion of the manifold 140. In some embodiments, and as described herein, once the first and second flexible prongs 150 are received in corresponding receptacles 158 of a manifold 140, rotation of the filter cartridge 110 in a first direction may be prevented, while rotation of the filter cartridge 110 in a second direction may be permitted.

The second end of the filter body 112 may include a cap 154 coupled the second end. In some embodiments, the cap 154 may be removably coupled to the filter body 112 to allow for the removal of the cap 154 and removal or placement of filter media within the filter body 112. In other embodiments, the cap 154 may be permanently coupled to the filter body 112. The cap 154 may include one or more ribs 156 that project radially and or longitudinally from the surface of the cap 154 to provide a gripping interface for installing and removing the filter cartridge 110.

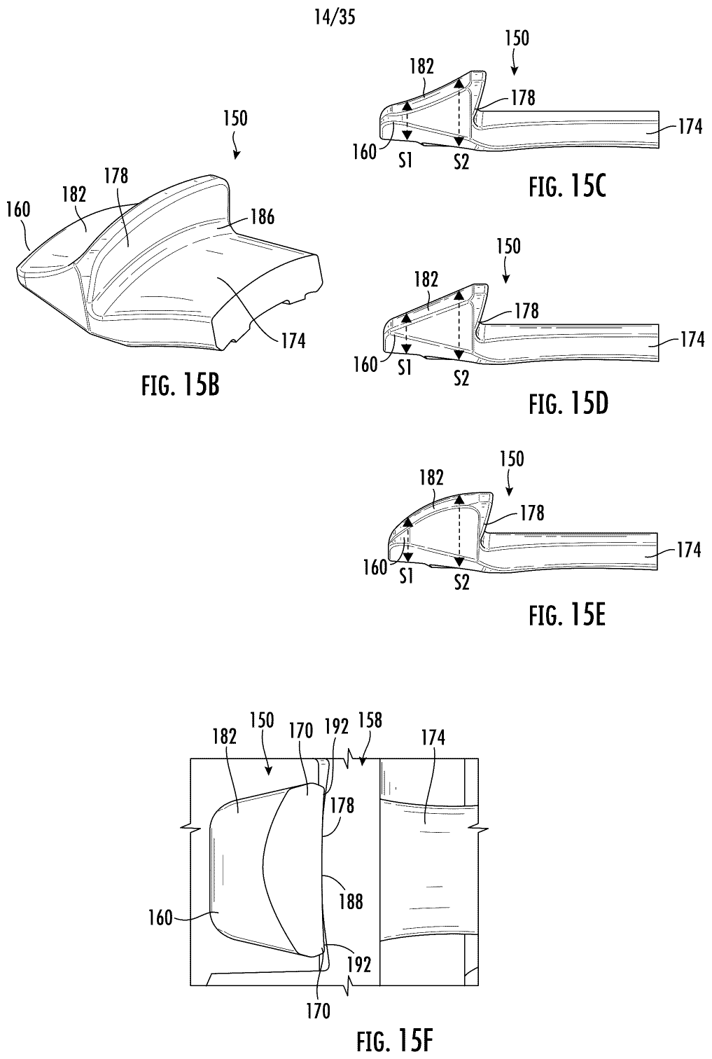

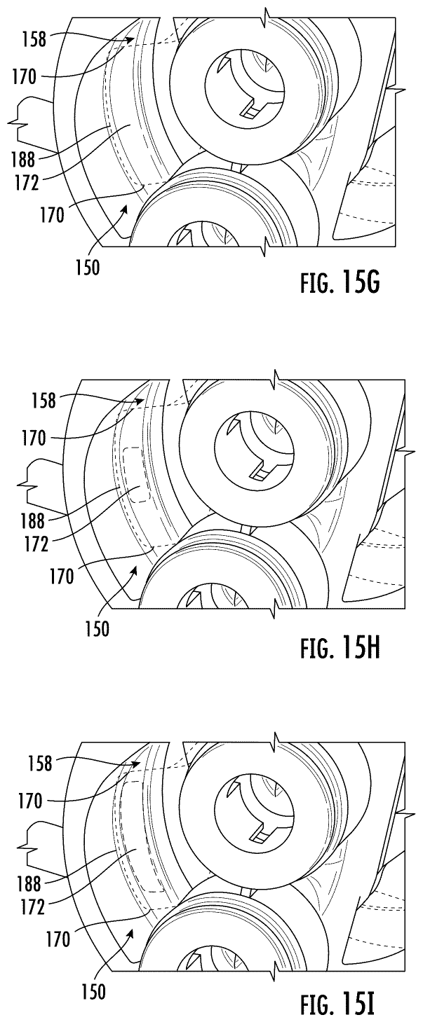

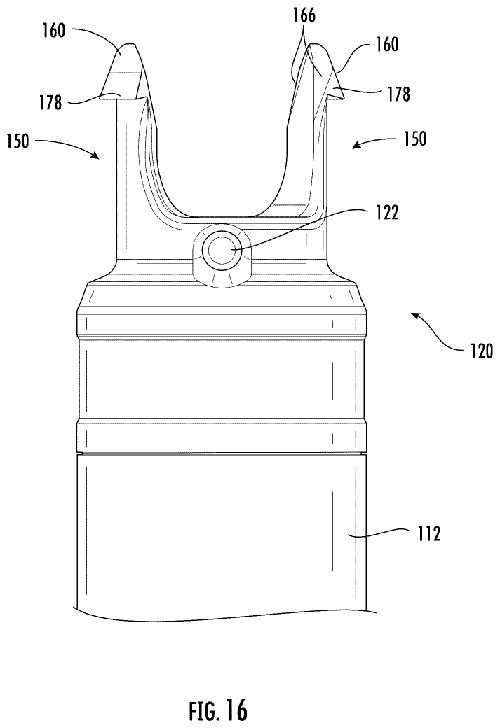

FIG. 15A illustrates a close-up, side view of the integrated locking head 120 of the filter cartridge 110, in accordance with an embodiment of the disclosure. FIG. 16 illustrates another close-up, side view of the integrated locking head 120 of the filter cartridge 110. As shown in FIG. 15A, each of the flexible prongs 150 may define neck portions 174 extending from a base. The neck portions 174 may be shaped to be narrower at the portions defining the free ends of the flexible prongs 150 (referred to as the heads 160) while being wider at the portions defining the fixed ends of the flexible prongs 150. The neck portions 174 may extend substantially parallel to the longitudinal axis in a direction opposite the insertion direction and a head portion at an end of the neck portion.

The free ends of the flexible prongs 150 may also include heads 160, which are rounded to be received into receptacles of the manifold 140 to be locked in place. The outer edge of the heads 160 may extend radially outward beyond the neck portion, which may be received by a space (receptacles 158) in the manifold 140 after insertion. Additionally, or alternatively, the heads 160, as well as chamfers 166 may serve to align and orient the flexible prongs 150 during the installation and removal processes. This design feature enables a margin of imprecision in initial flexible prong placement, as the interfaces between flexible prongs 150 and the manifold 140 are guided, thus allowing subsequent correction to achieve the intended precise positioning.

Additionally, or alternatively, and as also shown in FIG. 15A, the free ends of the flexible prongs 150, may include latch features 178 which provide a flared edge. The edge of the head portion may extend radially outward from the neck portion, which may permit the latching latch features 178 to sit in the receptacles and prevent movement of the filter cartridge 110 in a direction opposite the insertion direction.

Referring now to FIG. 15B a perspective view of a flexible prong 150 of an integrated locking head of a filter cartridge is illustrated, in accordance with an embodiment of the disclosure. As previously described, the head 160 of the flexible prong 150 may take one of many shapes. In particular, proximate the transition between the neck 174 and the head 160, a latch feature 178 may be provided. In some embodiments, the latch feature may be accompanied by one or more fillets 186 to interface with corresponding portions of the manifold once the filter cartridge 110 has been installed. Though fillet 186 may be depicted in FIG. 15B as having a round profile, it may alternatively have other shapes, such as chamfers, beveled edges, or any other suitable geometrical configuration.

Forming a portion of the head 160 and extending from the latch feature 178 may be a transition face 182. The transition face 182 may provide for controlled flexing of the flexible prong 150. As the flexible prong 150 is inserted into the manifold, the transition face 182 of the flexible prong 150 comes into contact with at least one corresponding surface on the manifold. This interaction exerts pressure on the flexible prong 150, causing it to displace (e.g., flex, rotate, bend, and/or the like). This inward (or outward) bending allows for a secure fit as the flexible prong 150 is guided into/out of the manifold, while also providing feedback to the user installing the filter cartridge 110 via mechanical resistance, such as to allow the user to infer the progress of the insertion/removal action.

As such, and as illustrated in FIGS. 15C-15E, the geometry of the transition face 182 may allow for various user experiences and filter cartridge insertion force characteristics.

It shall be appreciated that, as a result of a larger moment arm, forces acting on the free end of the flexible prong 150 proximate a tip of the head 160 cause greater displacement (e.g., flexing) of the flexible prong 150 than similar forces acting closer to the fixed end of the flexible prong 150 (i.e., with a shorter moment arm).

As used hereinafter with reference to FIGS. 15C-15E, S1 may refer to a first thickness of the head 160 at a first point in the longitudinal direction, while S2 may refer to a second thickness of head 160 at a second point in the longitudinal direction, the second point being closer to the fixed end of the flexible prong 150 than the first point.

In some embodiments, the first thickness S1 may be smaller than the second thickness S2. In other embodiments, the first thickness S1 may be substantially equal to the second thickness S2. In some embodiments, at least a portion of the transition face 182 may be concave (curved inwardly) between S1 and S2, as shown in FIG. 15C. This concave geometry results in the steepest slope being near the second thickness S2, close to the latch feature 178. Consequently, frictional forces between the transition face 182 and the corresponding features of the manifold increase as the flexible prong 150 advances. This frictional force grows until the latch feature 178 engages with the receptacle 158, allowing the flexible prong 150 to expand radially outward. The increase in frictional force may be further compounded by the decreased moment arm, which increases the force required to displace (e.g., flex, rotate, and/or the like) the prong near its fixed end, particularly near the second thickness S2. As a result, a user installing the filter cartridge 110 may feel a sharp or exponential increase in the required installation force throughout the installation process.

In some embodiments, at least a portion of the transition face 182 may be linear (i.e., flat) between S1 and S2, as illustrated in FIG. 15D. This linear geometry results in substantially the same slope at both the first thickness S1 and the second thickness S2, close to the latch feature 178. Consequently, frictional forces between the transition face 182 and the corresponding features of the manifold may stay constant or increase at a linear rate as the flexible prong 150 advances. This frictional force may be sustained until the latch feature 178 engages with the receptacle 158, allowing the flexible prong 150 to expand radially outward. The frictional force may be further compounded by the decreased moment arm, which increases the force required to displace (e.g., flex, rotate, and/or the like) the prong near its fixed end, particularly near the second thickness S2. As a result, a user installing the filter cartridge 110 may feel a constant increase in the required installation force throughout the installation process.

In some embodiments, at least a portion of the transition face 182 may be convex (i.e., curved outwardly) between S1 and S2, as illustrated in FIG. 15E. This convex geometry results in the steepest slope being near the first thickness S1, closest to the tip of the head 160. Consequently, frictional forces between the transition face 182 and the corresponding features of the manifold decrease as the flexible prong 150 advances. This frictional force decreases until the latch feature 178 engages with the receptacle 158, allowing the flexible prong 150 to expand radially outward. The decrease in frictional force may be offset by the decreased moment arm, which increases the force required to displace (e.g., flex, rotate, and/or the like) the prong near its fixed end, particularly near the second thickness S2. As a result, a user installing the filter cartridge 110 may feel minimal changes in the required installation force throughout the installation process (e.g., the required installation force may remain substantially constant throughout the installation process).

FIG. 15F illustrates a cutaway view of a flexible prong 150 received by a receptacle 158 of a manifold, in accordance with the embodiment of FIG. 15B. It shall be appreciated that, after installation, and during use of the filter cartridge within an appliance (e.g., while water traverses through the filter cartridge 110), jerk, acceleration, deceleration, and/or constant forces in the longitudinal direction of the filter cartridge 110 may cause stresses, fractures, and/or other fatigue in components of the present system that are intended to retain the filter cartridge 110 within the manifold during such uses.

Due to the stresses or forces within the system, the filter cartridge 110 and/or manifold materials may undergo temporary or permanent deformation. These deformations, though seemingly minor, may concentrate stress in certain areas, potentially leading to premature component failures. For example, when the filter cartridge 110 is filled with fluid (e.g., water during installation), the flexible prongs 150 may transfer energy, causing the receptacles 158 of the manifold to bend. Prior to the receptacles 158 bending, the interface region(s) between the receptacles 158 and prongs 150 may have identical curvatures (e.g., to form a large contact area). However, the bending may reduce the contact area by changing one or both curvatures, increasing the force on a smaller area and potentially causing failure in the receptacles 158 and/or prongs 150.

To avoid such failures, the latch feature 178 of flexible prong 150 may be provided with a curvature different than that of its corresponding receptacle 158. For example, the latch feature 178 may include a radius larger than that of the radius of the corresponding receptacle 158. As another example, the latch feature 178 may include curvature defined by a varying radius such that the radius of an inner portion 188 is larger (e.g., the curvature is flatter at the inner portion 188) than that of the edge portions 170. Regardless of the chosen geometry, the latch feature 178 may be configured such that at a resting state (i.e., without the filter cartridge 110 having any external forces thereon) the inner portion 188 of the latch feature 178 is in contact with the receptacle 158, while the edge portions 170 are displaced away from the receptacle 158, causing the presence of gaps 192.

As illustrated in FIG. 15G, at a resting state, only a small point of the inner portion 188 may be in contact with the receptacle 158. As shown in FIG. 15H, upon the initial presence of forces upon the filter cartridge 110 in the longitudinal direction, the interface region 172 grows larger and results in a larger area of contact between the receptacle 158 and the flexible prong 150, primarily due to deformation of the receptacle 158 and/or the flexible prong 150. As shown in FIG. 15I, increased forces and/or duration of forces upon the filter cartridge 110 in the longitudinal direction may result in the interface region growing even larger. As a result of the increase in size of the interface region 172 during added forces upon the filter cartridge 110, forces are spread over a larger area, resulting in increased durability and/or lifespan of the system.

As shown in FIGS. 15A and 16, the key 122 may be shaped as an extruded cylinder, and, as described further herein, the key 122 may interact with a keyway in a tube of the manifold 140. In some embodiments, the key 122 may have a cylindrical-shape with a beveled and/or curved outer edge where the sidewalls of the cylinder meet the circular end of the key 122 (e.g., the upward-facing surface in the orientation shown in FIG. 15A).

In other embodiments, the key 122 may be substantially oval in cross sectional shape, rhomboidal, star-shaped, hexagonal, triangular, or any other combination of polygonal and/or curved shape.

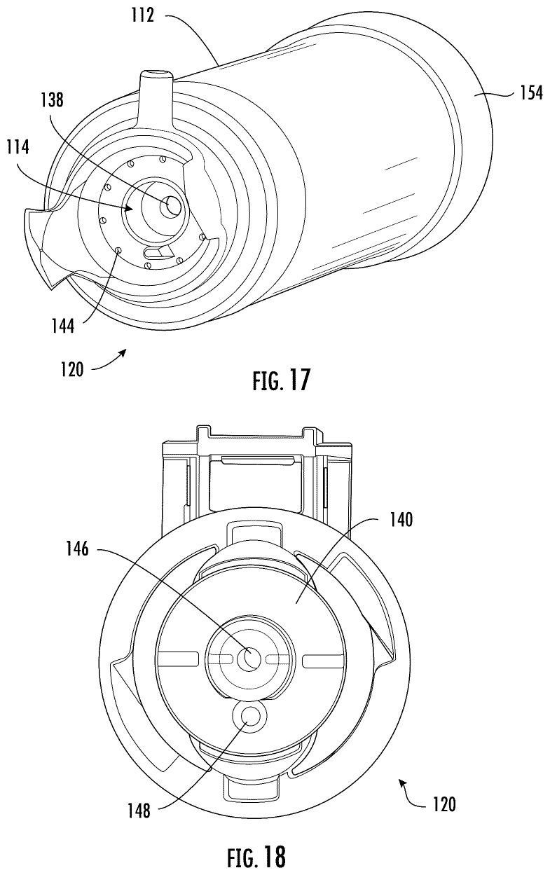

Referring now to FIGS. 17 and 18, the integrated locking head 120 interfaces with the contents of the filter body 112, such as filtration media. For example, in some embodiments, the fluid inlet and outlet 114 may include a central opening 138 in the integrated locking head for receiving water from the manifold 140 and a plurality of holes 144 positioned in a ring-shape radially offset from the central opening 138 for providing filtered water exiting the filtration media to the manifold 140. In some embodiments, the integrated locking head 120 may include a raised boss extending in a substantially longitudinal direction structured to actuate a corresponding poppet valve of the appliance, thereby enabling the flow of water.

As illustrated in FIG. 18, which illustrates the filter cartridge positioned within a portion of the manifold 140 (the manifold 140 being shown as a cutaway view for clarity), after the filter cartridge has been positioned within a portion of the manifold 140 of an appliance, the fluid inlet and outlet 114 may be in fluid communication with the manifold 140. Unfiltered fluid from the manifold 140 passes through the manifold hole 146, and through central opening 138 of the integrated locking head 120. The central opening 138 may be in fluid communication with at least a portion of the cavity within the filter body 112, which contains the filtration media. The fluid may then be filtered through the filtration media. The filtered fluid (or other fluid contents within the filter body 112), then exits the filter cartridge through the plurality of holes 144 in the integrated locking head 120, and may be then directed into the bottom hole 148 of the manifold.

FIG. 19 illustrates a close-up, side view of the filter cartridge 110 and a portion of a manifold 140 of an appliance. As shown in FIG. 19, the filter cartridge 110 assembly may include a manifold 140. In some embodiments, the manifold 140 assembly may further include a guard 152 including one or more latching mechanisms 196 coupled to an outer portion of the manifold 140. The latching mechanism 196 may include a latch feature 198 that allows the capturing of the manifold 140 by the latching mechanism after assembly. In some embodiments, the manifold 140 may include features similar to those of manifold 40, as previously shown and described with respect to FIGS. 4-5. However, it will be appreciated that there are differences such as receptacles 158 that may be included for the manifold 40 to integrate with the integrated locking head 120.

The guard 152 may include bosses protruding from the base portion 194, or solid portions of the base portion 194, which are structured to fill negative spaces between the manifold 140 and the filter cartridge 110, such as to prevent an unauthorized filter cartridge from functioning optimally within the appliance. Non-limiting examples of such negative spaces are shown in FIG. 19 as areas between the filter cartridge and the manifold that do not contain any physical structure in FIG. 19.

The manifold 140 may further include fluid connectors 116, structured to send and receive liquid to and from corresponding portions of the inlet and outlet 114 of the filter cartridge 110. The fluid connector 116 of the manifold 140 provides a fluid connection between the internal components of the appliance and the fluid inlet and outlet 114 of the filter cartridge 110.

FIG. 20 illustrates a perspective view of the manifold 140 with the filter cartridge 110 inserted therein. FIG. 21 illustrates a perspective view of the manifold 140 with the filter cartridge 110 inserted therein with portions of the manifold 140 and extraction guide 142 removed. As shown in FIGS. 20 and 21, the manifold 140 may include an extraction guide 142 having a keyway 134. In some embodiments, keyway 134 may be straight and extend parallel to the longitudinal axis of the filter cartridge 110. In some embodiments, the keyway 134 may be similar to keyway 34, as previously shown and described with respect to FIGS. 6-8. When a user inserts the filter cartridge 110, the key 122 on the integrated locking head 120 may pass through keyway 134, and keyway 134 may prevent rotation of the filter cartridge 110 during insertion.

In some embodiments, when the key 122 is positioned in the keyway 134, the keyway 134 prevents rotation of the filter cartridge 110, aligns flexible prong 150 with one of the two receptacles 158 and another flexible prong 150 with another of the two receptacles 158, and aligns the fluid inlet and outlet 114 of the filter cartridge 110 with the fluid connector 116 of an appliance. In some embodiments, and as shown in FIGS. 20 and 21, the extraction guide 142 may include an insertion end 134a for receiving and guiding the key 122 into the keyway 134, where the insertion end 134a may be wider than the keyway 134, which may improve the ability of a user to insert the key 122 into the keyway 134 and the filter cartridge 110 into the appliance.

In some embodiments, the filter cartridge 110 may be housed within the extraction guide 142, with a key 122 of said filter cartridge 110 precisely aligned with a keyway 134 within the extraction guide 142 during the insertion process. Contained within the guide 142 may be an aperture 162 positioned along a segment of the keyway 134. This aperture 162 may be configured such that, when the key 122 of the filter cartridge 110 traverses it, extending beyond the confines of the aperture 162, the key 122 becomes detectable by a sensor 164. The sensor 164 may be functionally linked to the aperture 162, enabling it to perceive the presence of the key 122 through the aperture 162, and when the key is in close proximity to the sensor.

The sensor 164 may be structured to read a section of the key 122 that may include graphic elements, ink patterns, barcodes, color variations, or similar distinguishing features. The data acquired through this reading process serves as input for the appliance to ascertain the authenticity of the filter cartridge 110. Additionally, or alternatively, the appliance may detect the presence of the filter cartridge 110 by assessing the proximity of the key 122 to the sensor 164, wherein the sensor 164 recognizes the proximity of the key 122 to the sensor 164 itself. In some embodiments, the key 122 may interact with the sensor 164 to indicate the presence and/or proper alignment of the filter cartridge 110. For example, the key 122 may push a button, switch, prong, and/or other type of element on the sensor 164 when fully inserted into the appliance.

In some embodiments, the sensor 164 may be operatively communicative with a controller of the appliance. The state of the sensor 163 (e.g., closed or opened) may be contingent upon the presence of the key 122. Upon activation or a change in state triggered by the presence of the key 122, for example the sensor 163 transitioning from a closed state to an open state, or an open state to a closed state, the controller may be configured to enable the flow of water through the filter cartridge via one or more valves and/or pumps. Conversely, in the absence of the key 122, and the non-activation or change in state of the sensor 164, the controller may prohibit the movement of water through the filter cartridge by precluding the activation of the one or more valves and/or pumps.

In some embodiments, the aperture 162 may only receive the key 122 when the filter cartridge 110 is in the locked position after installation (see FIG. 20). In other embodiments, the aperture 162 may receive the key 122 when the filter cartridge 110 is fully inserted into the manifold 140, but not in the locked configuration (see FIG. 21).

In some embodiments, the guide 142 may further comprise a secondary keyway 136. While keyway 134 may be substantially a straight configuration defining a straight channel parallel to the longitudinal axis direction of the guide 142, the secondary keyway 136 may be substantially curvilinear in shape and defines a curvilinear channel, where the entrance to the secondary keyway 136 may be connected to the portion of the keyway 134 including the aperture 162, and the exit of the secondary keyway 136 may be connected to the keyway 134 proximate the insertion end 134a of the keyway 134. In some embodiments, the secondary keyway 136 may be similar to secondary keyway 36, as previously shown and described with respect to FIGS. 6 and 13.

The secondary keyway 136 guides the key 122 of the filter cartridge 110 during the process of removing the filter cartridge 110 from the manifold 140. As may be described further herein, during the removal process, the filter cartridge 110 may be rotated counterclockwise from the perspective of a user, thereby aligning the key 122 with the secondary keyway, subsequently allowing for the key 122 to follow the curvilinear channel defined by the secondary keyway 136. Such following of the curvilinear channel prevents the interference of portions of the filter cartridge 110 (such as the flexible prongs 150) with portions of the manifold 140 intended to guide the removal (such as guides 180, 184).

The secondary keyway 136 may include a backstop 136a to directionally allow the traversing of the key 122 along the secondary keyway 136 during removal, while preventing the key 122 from traversing the secondary keyway 136 during installation. To do so, the backstop 136a may be a flexible tab anchored to the secondary keyway 136 at one fixed end of the flexible tab, while the free end extends above the surface of the secondary keyway 136. During removal, the key 122 makes contact with the backstop 136a at the fixed end, applies pressure as a result of the narrowing of the available space in the secondary keyway 136 for the key 122, thereby gradually deflecting the backstop 136a out of the path of the key 122.

In some embodiments, key 122 (or key 22, as illustrated in FIGS. 1-13) may include perforations or other strength-compromising features such that the key 122 may be retained within the aperture 162 when the key 122 may be coupled with an adhesive matter, such as glue, tape, cement, or the like. Additionally, or alternatively, the key 122 may be a separate body temporarily attached or adhered to the integrated locking head 120, and included with an adhesive matter. Additionally, or alternatively, the key 122 may include one or more latching features structured to receive portions of the aperture 162 or surrounding features of the extraction guide.

Accordingly, upon insertion of the filter cartridge 110, the key 122 may stick, adhere, or otherwise be captured by the aperture 162 or surrounding features of the extraction guide, and remain extending beyond the confines of the aperture 162 such that they key 122 may be detectable by the sensor 164 even after removal of the filter cartridge 110. In this way, a filter cartridge 110 without a key 122 may be inserted into the appliance and used without being inhibited by any functionality lock-out as a result of not having a key 122 included as a portion of the filter cartridge 110.

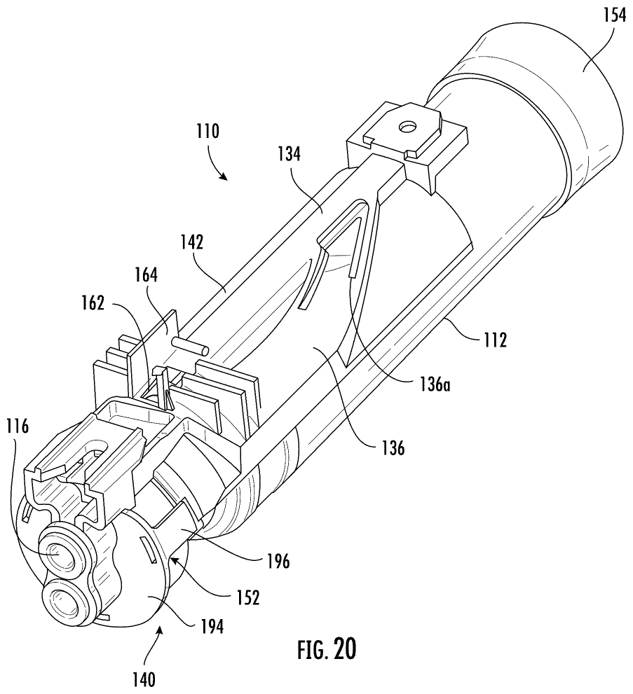

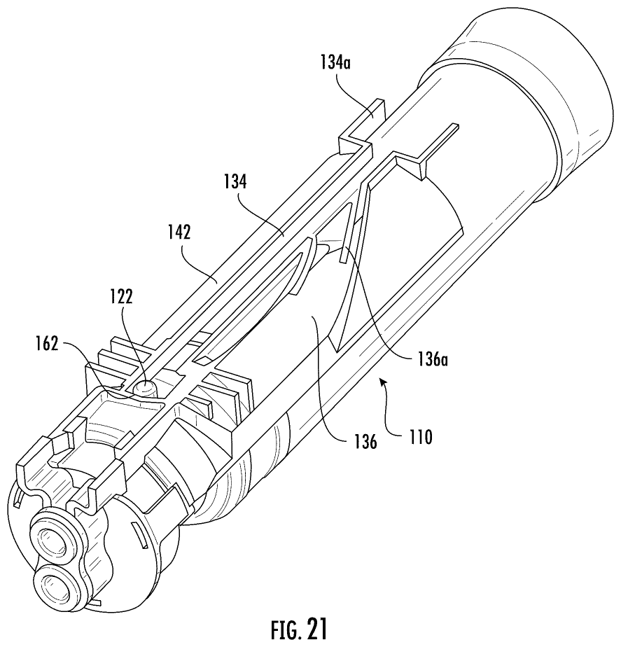

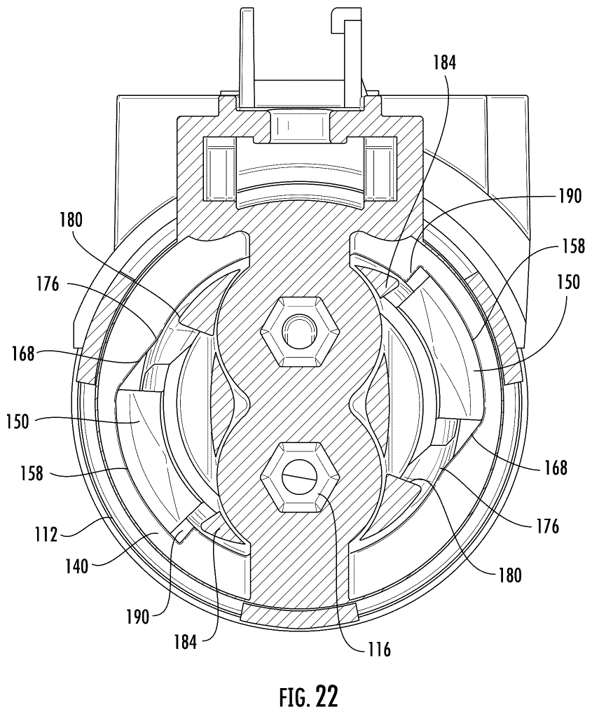

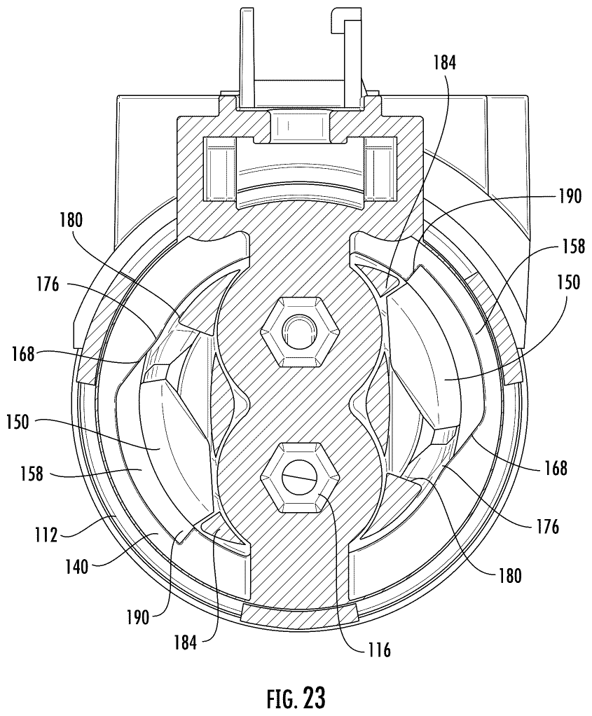

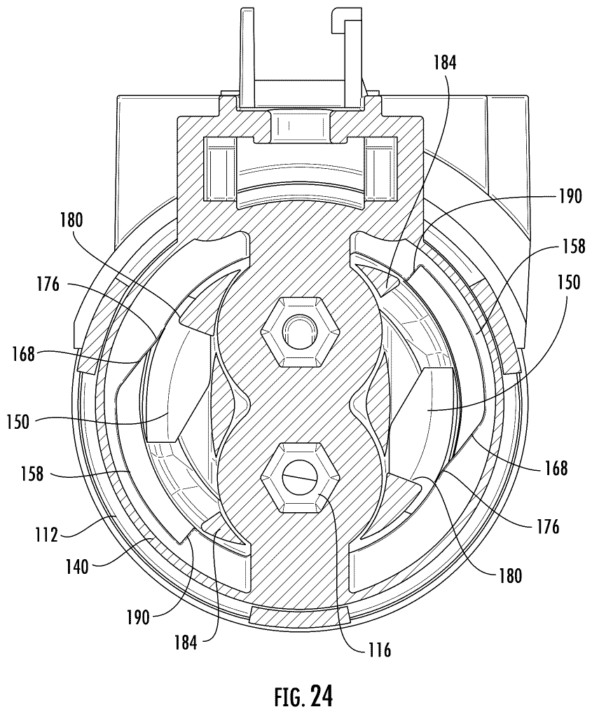

FIG. 22 illustrates a side, cross-section view of the integrated locking head 120 of the filter cartridge 110 and flexible prongs of the manifold 140 after insertion of the filter cartridge 110 into the manifold 140. The flexible prongs 150 show a partially relaxed state in FIG. 20, positioned closer to their inherent configuration relative to the filter cartridge 110 than during the insertion or installation phases of the filter cartridge 110, as will be shown with respect to FIGS. 23 and 24.

The manifold 140 may be characterized by a predominantly curved interior surface 176. Once locked, the flexible prongs 150 are held within corresponding receptacles 158 situated on the curved interior surface 176 of the manifold 140. These receptacles exhibit a curved wall with a radius substantially congruent with that of the outer surface of the flexible prongs 150. Consequently, due to the semi-relaxed state of the flexible prongs (i.e., not fully relaxed), some radial compressive forces may be generated between the curved wall and the respective outer surfaces of flexible prongs 150, resulting in the induction of friction between the curved wall and said outer surfaces, leading to a propensity to prevent the rotation of the filter cartridge 110 without intentional rotational input.

One side of each receptacle 158 features a stop element 190, extending radially from the curved wall to function as an impediment to the rotation of the filter cartridge 110. These stop elements 190 establish an upper limit on the rotational range of the flexible prongs 50 by interacting with their surfaces to prevent rotation.

In some embodiments, the manifold 140 may incorporate guides 180, 184 substantially aligned with the axis of the filter cartridge 110. These guides serve to avert incorrect flexible prong 150 positioning at various stages along the insertion path. For example, guides 180 situated at the fluid connector 116 of the manifold 140 guide the flexible prongs to be rotated to a specific orientation during insertion and/or removal.

The opposite side of each receptacle 158, away from the stop element, features a curved transition surface 168. These curved transition surfaces smoothly connect the curved walls of the receptacles 158 to the curved interior surface 176 of the manifold 140 to allow the filter cartridge 110 to be rotated counterclockwise (from the user's perspective) for removal of the filter cartridge 110. Unlike the stop elements 190 in each receptacle, the curved transition surfaces permit filter cartridge 110 rotation in the direction of these curved transition surfaces 168. However, the curved transition surfaces narrow the diameter of the flexible prongs 150 incrementally during rotation, causing the flexible prongs to displace (e.g., flex, rotate, and/or the like) radially inward, thereby introducing additional opposing radial forces between the curved transition surfaces 168 and the corresponding outer surfaces of flexible prongs 150 resulting in increased friction to provide natural resistance against unwanted rotation.

Upon reaching the maximal radial flexure permitted by the curved transition surfaces 168 due to filter cartridge 110 rotation, a portion of the flexible prongs 150 may rest adjacent to the curved interior surface 176 of the manifold 140, as illustrated in FIG. 22. This arrangement enables removal of filter cartridge 110 by subsequently shifting the filter cartridge 110 along its longitudinal axis direction.

FIG. 23 illustrates a side, cross-section view of the integrated locking head 120 of the filter cartridge 110 in the context of insertion procedure, wherein the flexible prongs 150 are currently disengaged from the receptacles 158. The curved interior surface 176 of the manifold 140 exerts a compressive force on the flexible prongs 150, inhibiting their outward expansion, while the curved outer surfaces of the flexible prongs 150 can smoothly glide in the longitudinal direction along the curved interior surface 176 of the manifold 140. By inserting the filter cartridge 110 fully into the manifold 140 by aligning the key 122 with the keyway 134 and subsequently moving the filter cartridge 110 in a linear fashion towards the manifold 140, heads 160 of the flexible prongs 150 are received by receptacles 158 following the release of compressive forces between the outer surfaces of flexible prongs 150 and the curved interior surface 176 of the manifold 140. These receptacles 158 may incorporate vertical walls to accommodate latch features 178 of the flexible prongs 150, thus preventing filter cartridge 110 removal along the longitudinal axis direction without the compression of flexible prongs 150.

FIG. 24 illustrates a side, cross-section view of the integrated locking head 120 of the filter cartridge 110 and the flexible prongs of the manifold 140 after rotation of the filter cartridge 110 within the manifold 140 during the removal process. In this configuration, both flexible prongs 150 are fully compressed owing to dimensional constraints imposed by the internal dimensions of the curved interior surface 176 of the manifold 140 after the filter cartridge 110 has been first rotated by a user in the counterclockwise direction. In some embodiments, the flexible prongs 150 may reach the limits of their travel in the longitudinal axis direction due to physical interference from guides 180.

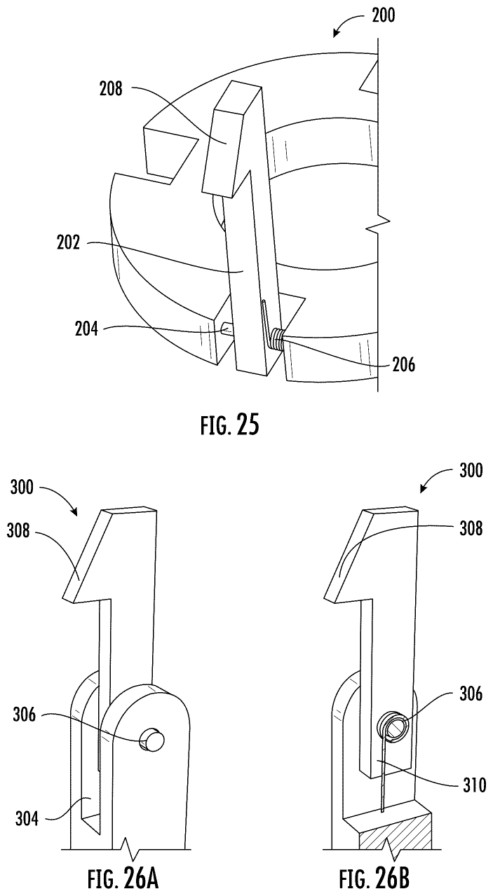

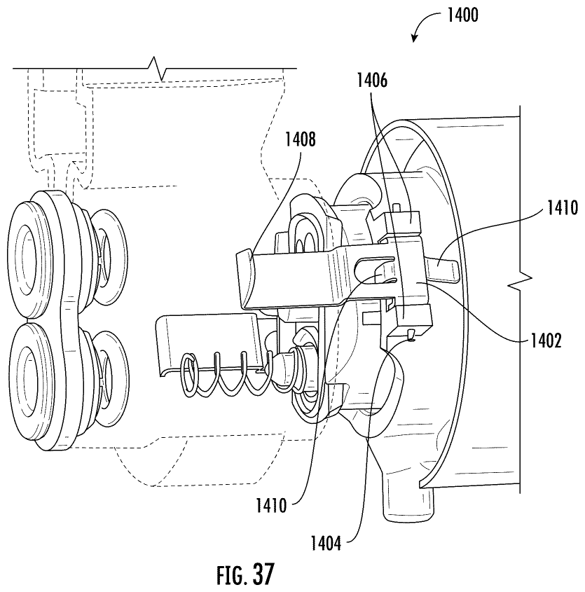

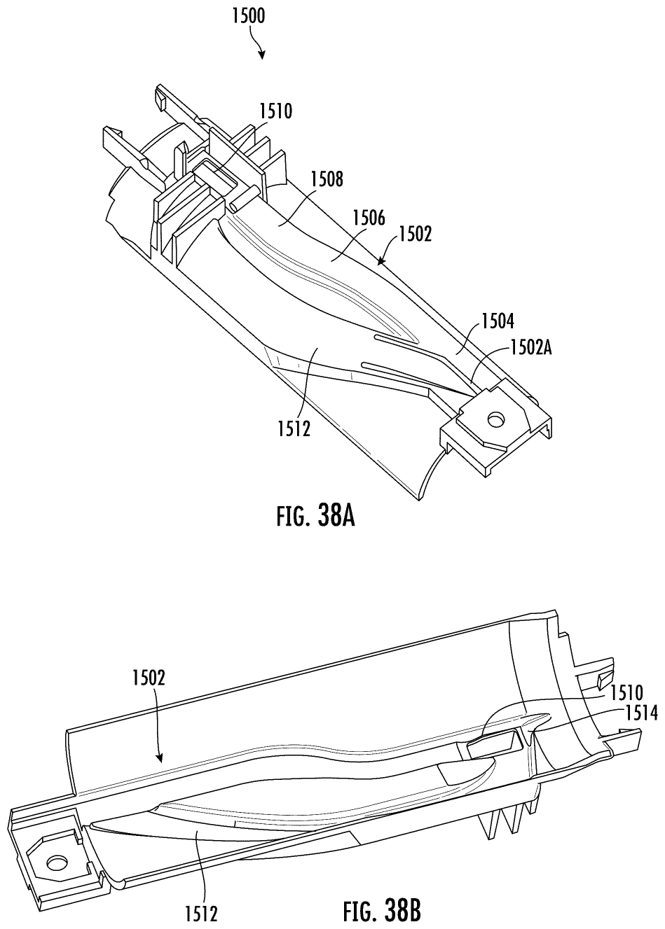

Indeed, in some embodiments, the relative size differences between the receptacles 158 of the manifold 140 and the size of the displaceable latch features (such as flexible prongs 150 or any other alternative attachment feature disclosed herein with respect to FIGS. 25-28, and FIG. 37) may be minimized such that the displaceable latch features are unable to be removed from the manifold 140. In other words, while some embodiments allow for rotation of the integrated locking head relative the manifold 140 such that the exterior surface(s) of the displaceable latch features are flexed inwards as a result of interaction with the curved interior surface of the manifold 140, in other embodiments, larger portions of the receptacles 158 are filled with the displaceable latch feature such that any rotation of the integrated locking head results in the physical interference between one or more vertical surfaces of the manifold 140 and portions of the displaceable latch feature(s). Such a design may be useful to allow for the permanent inclusion of an adapter or locking head of a refillable filter cartridge (such as those disclosed in FIGS. 38A-42C) without having to interact with the manifold 140 each time a filter is to be removed or changed. Of course, the aforementioned design features may also be applied to the integrated locking head 20 and manifold 40 described with respect to FIGS. 1-13 to prevent the rotation thereof after insertion.

In some embodiments, the present disclosure embraces a method of inserting a filter cartridge 110 into a filter manifold 140. First, the method may include aligning the key 122 (FIGS. 14-16) with the insertion end 134a of keyway 134 of the extraction guide 142 (FIGS. 20-21) and inserting, in an insertion direction, the filter cartridge 110 into the manifold 140 such that the key 122 passes through keyway 134. While inserting the filter cartridge 110 in the insertion direction, the flexible prongs 150 are compressed towards each other as a result of the distance between opposite sides of the curved interior surface 176 of the manifold 140 being more narrow than the resting distance between outer portions of the flexible prongs 150. Next, the method may include engaging the flexible prongs 150 with the receptacles 158 (FIG. 22) and forcing the heads 160 to enter the receptacles 158 as a result of the natural release of compression of the flexible prongs 150 after the inward deflection of the heads 160 is overcome and the heads 160 enter the receptacles 158. The method may also include engaging the latch features 178 with corresponding vertical walls of the receptacles 158 to prevent the unwanted removal along a longitudinal direction. In some embodiments, the method may include, after heads 160 of the flexible prongs 150 enter the receptacles 158, preventing, with the stop element 190 of the receptacles 158 (FIGS. 22-24), rotation of the filter cartridge 110 in a first direction (e.g., a clockwise direction). In some embodiments, this method may include the key 122 being exposed through an aperture 162 of the keyway 134. In some embodiments, this method may also include a sensor 164 coupled to the keyway 134 detecting the presence of the key 122 through the aperture 162.

The present disclosure may also embrace a method of removing a filter cartridge 110 from a filter manifold 140. The method may include, after the flexible prongs 150 are positioned in the receptacles 158, permitting, with the curved transition surfaces 168 adjacent the receptacles (FIGS. 22-24) rotation of the filter cartridge 110 in a second direction opposite the first direction (e.g., a counterclockwise direction). The method may include, after the flexible prongs 150 are positioned in the receptacles 158, rotating the filter cartridge 110 in the second direction and forcing, with the curved transition surfaces 168, the flexible prongs 150 to displace (e.g., flex, rotate, and/or the like) radially inward to disengage from the receptacles 158 and engage the curved interior surface 176 of the manifold 140 (FIG. 24). In some embodiments, the method may include preventing rotation of the of the filter cartridge 110 in the first direction with the stop elements 190.

In some embodiments, the method may include, after forcing, with the curved transition surfaces 168, the flexible prongs 150 to displace (e.g., flex, rotate, and/or the like) radially inward to disengage from the receptacles 158 and engage the curved interior surface 176 of the manifold 140, pulling the filter cartridge 110 in an extraction direction opposite the insertion direction, such that the key 122 enters secondary keyway 136. The method may also include pulling the filter cartridge 110 in the extraction direction such that the key 122 passes through secondary keyway 136, bends the backstop 136a, and enters keyway 134. The method may further include pulling the filter cartridge 110 in the extraction direction such that the key 122 passes through keyway 134 and the insertion end 134a and withdrawing the filter cartridge 110.

In some embodiments, the flexible prongs 150 may be replaced with alternative latching mechanisms, such as those shown in FIGS. 25-28 and 37. These alternative latching mechanisms, similar to the flexible prongs 150, may interact with the manifold 140 illustrated in FIGS. 18-24 such as to secure the filter cartridge 110 in the appliance. For example, FIG. 25 illustrates a perspective view of a portion of an integrated locking head 200 of a filter cartridge, in accordance with an alternative embodiment of the disclosure. The integrated locking head 200 may include at least one rotating prong 202, where the rotating prong 202 may be rotatably coupled to an axle 204 within the integrated locking head 200 of the filter cartridge.

In some embodiments that include the at least one rotating prong 202, one or more of the flexible prongs 150 illustrated in the filter cartridge of FIG. 14 may be replaced with the at least one rotating prong 202 shown in FIG. 25, with the at least one rotating prong 202 holding the filter cartridge in place by securing the integrated locking head 200 to the manifold 140. Accordingly, the manifold 140, such as that which is illustrated in FIGS. 18-24, may receive the integrated locking head 200 by latching the integrated locking head 200 into the one or more receptacles 158 of the manifold 140. With the exception of one or more flexible prongs 150 being replaced with one or more one rotating prongs 202, the integrated locking head 200 may otherwise be substantially similar to the integrated locking head 120 shown in FIGS. 14-24.

The rotating prong 202 may receive a torsion spring 206 or other spring element structured to apply a force to the rotatable prong 202, thereby keeping the rotatable prong 202 engaged within a receptacle in the manifold. The rotating prong 202 may include a latching feature 208 to interact with a corresponding receptacle of the manifold 140, such as the receptacles 158 illustrated and described with respect to FIGS. 18-24. Upon insertion of the integrated locking head 200 into a manifold, the at least one rotating prong 202 may rotate inwards (e.g., towards the longitudinal axis of the filter cartridge) about the axle 204, causing the spring 206 to exert a torque in the opposite direction to the applied force, attempting to return the at least one rotating prong 202 to its original position. Once the at least one rotating prong 202 reaches a receptacle in the manifold, the torque from the spring 206 causes the latching feature 208 to rotate outwards (e.g., away from the longitudinal axis of the filter cartridge), such that the latching feature 208 extends past a vertical wall of the manifold, preventing the linear removal of the integrated locking head 200 once the manifold 140 receives the integrated locking head 200 by latching the integrated locking head 200 into the one or more receptacles 158 of the manifold 140. In some embodiments, the integrated locking head 200 may be removed by rotating the filter cartridge in a similar manner as that which may be described with respect to FIGS. 22-24, rotating the at least one rotating prong 202 in an inward direction via the curved transition surface of the manifold 140. In other embodiments, the at least one rotating prong 202 may be sized sufficiently large such that removal, even by rotation, may be prevented. In some embodiments, the rotating prong 202 In some embodiments, such a rotating prong may replace and/or be used in conjunction with a latching mechanism, a displaceable latch feature, a flexible prong, and/or the like as disclosed in other embodiments described herein.

FIGS. 26A and 26B illustrate perspective views of a rotatable prong 300 of an integrated locking head, in accordance with an alternative embodiment of the disclosure. Unlike the rotating prong 202 of FIGS. 25, the rotatable prong 300 may be received within a prong mount projecting from the integrated locking head, where the prong mount has a slot 304, and the rotatable prong 300 rotatably coupled to an axle 306 extending between the two sides of the slot 304 disposed from one another. The rotatable prong 300 may also include a latching feature 308 for interacting with a corresponding receptacle in the manifold in which the rotatable prong 300 may be engaged, such as the receptacles 158 illustrated and described with respect to FIGS. 18-24.

In some embodiments that include at least one of the rotatable prongs 300, one or more of the flexible prongs 150 illustrated in the filter cartridge of FIG. 14 may be replaced with the at least one rotatable prongs 300 shown in FIGS. 26A and 26B, with the at least one rotatable prong 300 holding the filter cartridge in place by securing the integrated locking head of FIGS. 26A and 26B to the manifold 140. Accordingly, the manifold 140, such as that which is illustrated in FIGS. 18-24, may receive the integrated locking head having at least one rotatable prong 300 by latching the at least one rotatable prong 300 into the one or more receptacles 158 of the manifold 140. With the exception of one or more flexible prongs 150 being replaced with one or more of the rotatable prongs 300, the integrated locking head may otherwise be substantially similar to the integrated locking head 120 shown in FIGS. 14-24.

The rotating prong 300 may receive a torsion spring 310 or other spring element structured to apply a force to the rotatable prong 300, thereby keeping the rotatable prong 300 engaged within a receptacle in the manifold. Upon insertion of the rotatable prong 300 into a manifold, the rotatable prong 300 may rotate inwards (i.e., towards the longitudinal axis of the filter cartridge) about the axle 306, thereby exerting a force in the opposite direction to the applied force, attempting to return to its original position. Once the rotatable prong 300 reaches a receptacle in the manifold, the torque from the spring 310 causes the latching feature 308 to rotate outwards (i.e., away from the longitudinal axis of the filter cartridge), such that the latching feature 308 extends past a vertical wall of the manifold, preventing the linear removal of the rotatable prong 300 once the manifold 140 receives the integrated locking head by latching the at least one rotatable prong 300 into the one or more receptacles 158 of the manifold 140. In some embodiments, the integrated locking head may be removed by rotating the filter cartridge in a similar manner as that which is described with respect to FIGS. 22-24, rotating the at least one rotatable prong 300 in an inward direction via the curved transition surface of the manifold 140. In other embodiments, the at least one rotatable prong 300 may be sized sufficiently large such that removal, even by rotation, may be prevented. In some embodiments, such a rotatable prong 300 may replace and/or be used in conjunction with a latching mechanism, a displaceable latch feature, a flexible prong, and/or the like as disclosed in other embodiments described herein. For example, such a rotatable prong may be positioned toward an end portion of a latching mechanism, a displaceable latch feature, a flexible prong, and/or the like.

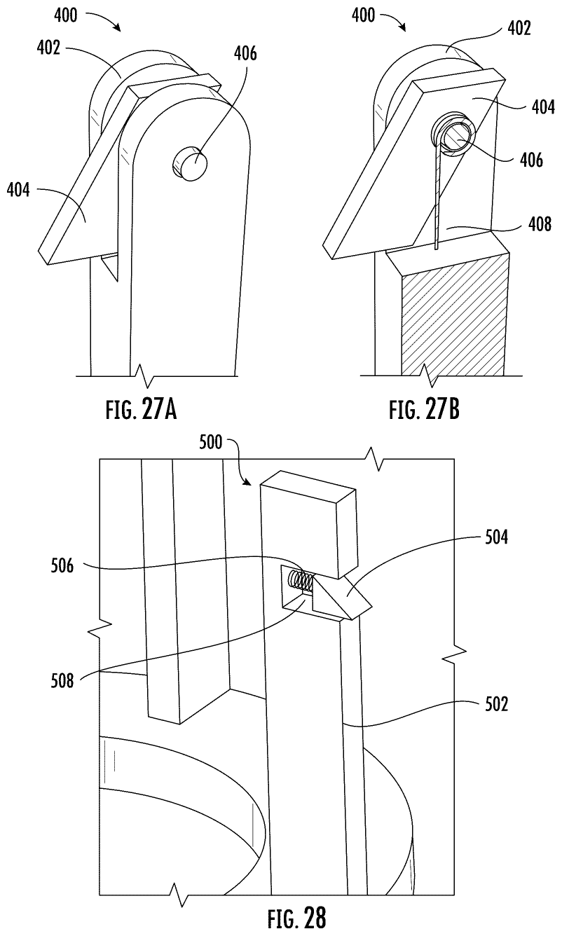

FIGS. 27A and 27B illustrate perspective views of a prong rotating latching mechanism 400 of an integrated locking head, in accordance with an alternative embodiment of the disclosure. Similar to FIGS. 26A and 26B, the prong mount includes a slot 402, with an axle 406 extending between disposed faces of the slot 402. Rotatably coupled to the axle 406 may be the latching mechanism 404 which is pictured in FIGS. 27A and 27B as having a substantially parallelogram shape.

In some embodiments that include one or more of the prong rotating latching mechanism 400, one or more of the flexible prongs 150 illustrated in the filter cartridge of FIG. 14 may be replaced with at least one of the prong rotating latching mechanism 400 shown in FIGS. 27A and 27B, with the prong rotating latching mechanism 400 holding the filter cartridge in place by securing the integrated locking head to the manifold 140. Accordingly, the manifold 140, such as that which is illustrated in FIGS. 18-24, may receive the integrated locking head having at least one of the prong rotating latching mechanisms 400 by latching the latching mechanism 404 into the one or more receptacles 158 of the manifold 140, such as the receptacles 158 illustrated and described with respect to FIGS. 18-24. With the exception of one or more flexible prongs 150 being replaced with one or more of the prong rotating latching mechanism 400, the integrated locking head may otherwise be substantially similar to the integrated locking head 120 shown in FIGS. 14-24.

A torsion spring 408 may be coupled to the latching mechanism 404 and affixed to the mount in order to provide rotational resistance and maintain the latching mechanism 404 engaged in the receptacle of the manifold. Upon insertion of the prong rotating latching mechanism 400 into a manifold, the latching mechanism 404 may rotate inwards (i.e., towards the longitudinal axis of the filter cartridge) about the axle 406, causing the spring 408 to exert a torque in the opposite direction to the applied force, attempting to return the latching mechanism 404 to its original position. Once the latching mechanism 404 reaches a receptacle in the manifold, the torque from the spring 408 causes the latching mechanism 404 to rotate outwards (i.e., away from the longitudinal axis of the filter cartridge), such that the latching mechanism 404 extends past a vertical wall of the manifold, preventing the linear removal of prong rotating latching mechanism 400 once the manifold 140 receives the integrated locking head by latching the latching mechanism 404 into the one or more receptacles 158 of the manifold 140. In some embodiments, the integrated locking head may be removed by rotating the filter cartridge in a similar manner as that which is described with respect to FIGS. 22-24, rotating the latching mechanism 404 in an inward direction via the curved transition surface of the manifold 140. In other embodiments, the latching mechanism 404 may be sized sufficiently large such that removal, even by rotation, may be prevented. In some embodiments, such a prong rotating latching mechanism may replace and/or be used in conjunction with a latching mechanism, a displaceable latch feature, a flexible prong, and/or the like as disclosed in other embodiments described herein. For example, such a prong rotating latching mechanism may be positioned toward an end portion of a latching mechanism, a displaceable latch feature, a flexible prong, and/or the like.

FIG. 28 illustrates a perspective view of a retracting latching mechanism 500 of an integrated locking head, in accordance with an alternative embodiment of the disclosure. A prong mount 502 may include a slot in a radial direction, opening in the direction of the outer surface of the filter cartridge and having a flat face.

In some embodiments that include at least one of the retracting latching mechanisms 500, one or more of the flexible prongs 150 illustrated in the filter cartridge of FIG. 14 may be replaced with the at least one retracting latching mechanism 500 shown in FIG. 28, with the at least one retracting latching mechanism 500 holding the filter cartridge in place by securing the integrated locking head 200 to the manifold 140. Accordingly, the manifold 140, such as that which is illustrated in FIGS. 18-24, may receive the retracting latching mechanism 500 by latching the latch 504 into the one or more receptacles 158 of the manifold 140. With the exception of one or more flexible prongs 150 being replaced with one or more of the retracting latching mechanism 500, the integrated locking head may otherwise be substantially similar to the integrated locking head 120 shown in FIGS. 14-24.

The latch 504 may be any number of geometries, shown graphically in FIG. 28 as have a substantially triangular in cross section, and may be coupled to a compression spring 506 affixed to the flat face of the prong mount 502, such that once the manifold receives the filter cartridge, the latch 504 retracts inwards to allow the passing of the filter cartridge through narrow passageways, and subsequently extending outwards once presented to a receptacle in the manifold. When aligned with a receptacle of the manifold, the latch 504 extends past a vertical wall of the manifold, preventing the linear removal of the retracting latching mechanism 500 once the manifold 140 receives the integrated locking head by latching the latch 504 into the one or more receptacles 158 of the manifold 140. In some embodiments, the integrated locking head may be removed by rotating the filter cartridge in a similar manner as that which is described with respect to FIGS. 22-24, squeezing the latch 504 in an inward direction via the curved transition surface of the manifold 140. In other embodiments, the latch 504 may be sized sufficiently large such that removal, even by rotation, may be prevented. In some embodiments, such a prong mount and/or retracting latching mechanism may replace and/or be used in conjunction with a latching mechanism, a displaceable latch feature, a flexible prong, and/or the like as disclosed in other embodiments described herein. For example, such a prong mount and/or retracting latching mechanism may be positioned toward an end portion of a latching mechanism, a displaceable latch feature, a flexible prong, and/or the like.

In some embodiments, one or more of the flexible prongs 150 may be replaced with alternative latching mechanisms structured to secure portions of the filter cartridge other than the head of the filter cartridge. Accordingly, the filter cartridge may be secured with various latching mechanisms (e.g., a retention device) that interact with the filter body and/or the end cap in lieu of, or in addition to, the one or more flexible prongs 150. Some embodiments of retention devices may be aftermarket components not otherwise sold with the appliance. Indeed, such retention devices may be sold with the purpose of adapting the appliance for use with filter cartridges not otherwise intended for use with the appliance. For example, FIG. 29 illustrates a side, cross-section view of a compression spring retaining device 600 that may be included in the filter cartridge 110 and function to retain the filter cartridge 110 within the manifold 140, in accordance with an alternative embodiment of the disclosure. The filter body of the filter cartridge 110 may include a recessed area 608 containing a spring 602 and a pin 604 attached thereto. During insertion or removal of the filter body to or from the extraction guide 606, the spring 602 may be in a compressed state, with the pin 604 below or at the outer surface of the filter body. However, once the pin 604 reaches a hole or recessed portion of the extraction guide 606, the spring 602 extends, causing the pin 604 to enter the hole or recessed portion, thus preventing the unwanted removal of the filter cartridge from the extraction guide 606. Alternatively, in some embodiments, the spring 602 featuring a securely affixed pin 604 within the extraction guide 606 that engages by extending into the filter body of the filter cartridge. In some embodiments, the pin 604 may be shaped as a cylinder. In other embodiments, the pin 604 may be spherical ball. Indeed, numerous other shapes of the pin 604 are contemplated.

In some embodiments that include a compression spring retaining device 600, the flexible prongs 150 illustrated in the filter cartridge of FIG. 14 may be replaced with the compression spring retaining device 600, with the pin 604 holding the filter cartridge in place by securing the filter body to the extraction guide. Accordingly, the manifold 140, such as that which is illustrated in FIGS. 18-24, may receive the filter cartridge by simple alignment and/or coupling of the manifold hole 146 of the manifold 140 and the central opening 138 of the integrated locking head, while the compression spring retaining device 600 secures the filter cartridge. With the exception of the one or more flexible prongs 150 no longer being present on the integrated locking head due to the alternative securing of the filter cartridge via the compression spring retaining device 600, the integrated locking head may otherwise be substantially similar to the integrated locking head 120 shown in FIGS. 14-24.

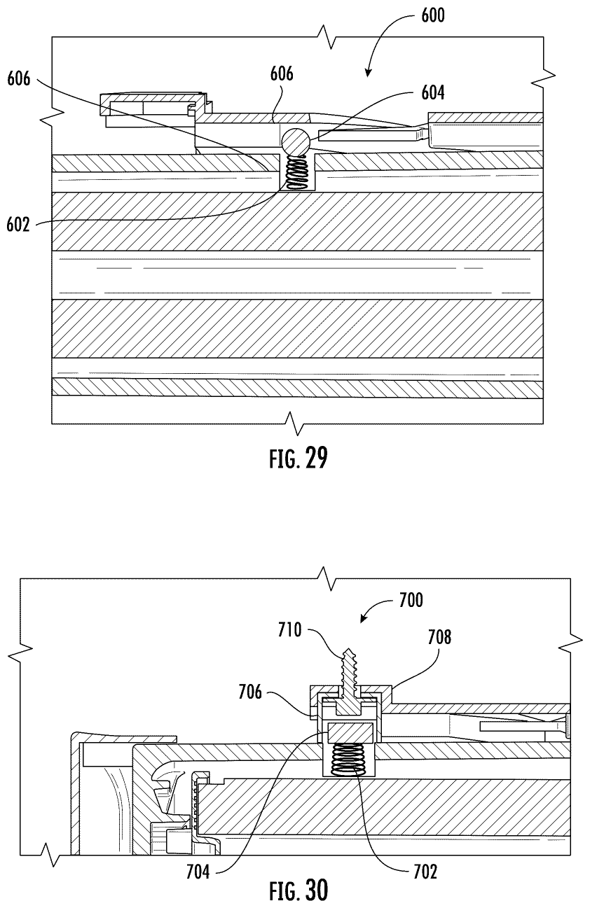

FIG. 30 illustrates a side, cross-section view of a compression spring retaining device 700 that may be included in the filter cartridge 110 and function to retain the filter cartridge 110 within the manifold 140, in accordance with an alternative embodiment of the disclosure. A spring 702 featuring a securely affixed pin 704 within the filter body engages by extending into a plate 706 that may be affixed to the extraction guide 708 by a fastener 710. The filter body of the filter cartridge 110 may include a recessed area containing a spring 702 and a pin 704 attached thereto. During insertion or removal of the filter body to or from the extraction guide 708, the spring 702 may be in a compressed state, with the pin 704 below or at the outer surface of the filter body. However, once the pin 704 reaches a recessed portion of the extraction guide 708 defined by the plate 706, the spring 702 extends, causing the pin 704 to enter the plate 706, thus preventing the unwanted removal of the filter cartridge from the extraction guide 708. In some embodiments, the pin 704 may be shaped as a cylinder. In other embodiments, the pin 704 may be spherical ball. Indeed, numerous other shapes of the pin 604 are contemplated.

In some embodiments that include a compression spring retaining device 700, the flexible prongs 150 illustrated in the filter cartridge of FIG. 14 may be replaced by the compression spring retaining device 700, with the pin 704 holding the filter cartridge in place by securing the filter body to the extraction guide. Accordingly, the manifold 140, such as that which is illustrated in FIGS. 18-24, may receive the filter cartridge by simple alignment of the manifold hole 146 of the manifold 140 and the central opening 138 of the integrated locking head, while the compression spring retaining device 700 secures the filter cartridge. With the exception of the one or more flexible prongs 150 no longer being present on the integrated locking head due to the alternative securing of the filter cartridge via the compressing spring retaining device 700, the integrated locking head may otherwise be substantially similar to the integrated locking head 120 shown in FIGS. 14-24.

In some embodiments, the compression spring retaining device 700 may be used alone or in combination with the flexible prongs 150 illustrated in the filter cartridge of FIG. 14 and/or the alternative latching mechanisms described with respect to FIGS. 25-28 and 37.

FIG. 31 illustrates a perspective view of a leaf spring retaining device 800 that may be included in the extraction guide 142 and function to retain the filter cartridge 110 within the manifold 140, in accordance with an alternative embodiment of the disclosure. In this embodiment, a leaf spring 802 may be affixed to the extraction guide 806, while the filter body contains a relief portion 804 that may be structured to be received by the leaf spring 802 upon installation of the filter cartridge. Accordingly, during the insertion and removal of the filter cartridge 110, the leaf spring 802 remains in a compressed state and applied force to the outer surface of the filter body as it maintains contact with the outer surface of the filter body. Thereafter, once the relief portion 804 of the filter body passes over the leaf spring 802, at least some of the compression within the leaf spring 802 may be relieved, then the leaf spring 802 expands into the relief portion 804, securing the filter body in the extraction guide 806 and preventing unwanted removal or insertion of the filter body.

The extraction guide 806 may include the features of the extraction guide 142 illustrated in FIGS. 20-21 with the addition of the leaf spring 802 affixed thereto, the extraction guide 142 having been modified with a mounting hole (or a preexisting mounting hole otherwise repurposed) for mounting the spring 802.

In some embodiments that include the leaf spring retaining device 800, the flexible prongs 150 illustrated in the filter cartridge of FIG. 14 may be replaced by the leaf spring retaining device 800, with the leaf spring 802 holding the filter cartridge in place by securing the filter body to the extraction guide. Accordingly, the manifold 140, such as that which is illustrated in FIGS. 18-24, may receive the filter cartridge by simple alignment and coupling of the manifold hole 146 of the manifold 140 and the central opening 138 of the integrated locking head, while the leaf spring retaining device 800 secures the filter cartridge. With the exception of the one or more flexible prongs 150 no longer being present on the integrated locking head due to the alternative securing of the filter cartridge via the leaf spring retaining device 800, the integrated locking head may otherwise be substantially similar to the integrated locking head 120 shown in FIGS. 14-24.

In some embodiments, the leaf spring retaining device 800 may be used alone or in combination with the flexible prongs 150 illustrated in the filter cartridge of FIG. 14 and/or the alternative latching mechanisms described with respect to FIGS. 25-28 and 37.

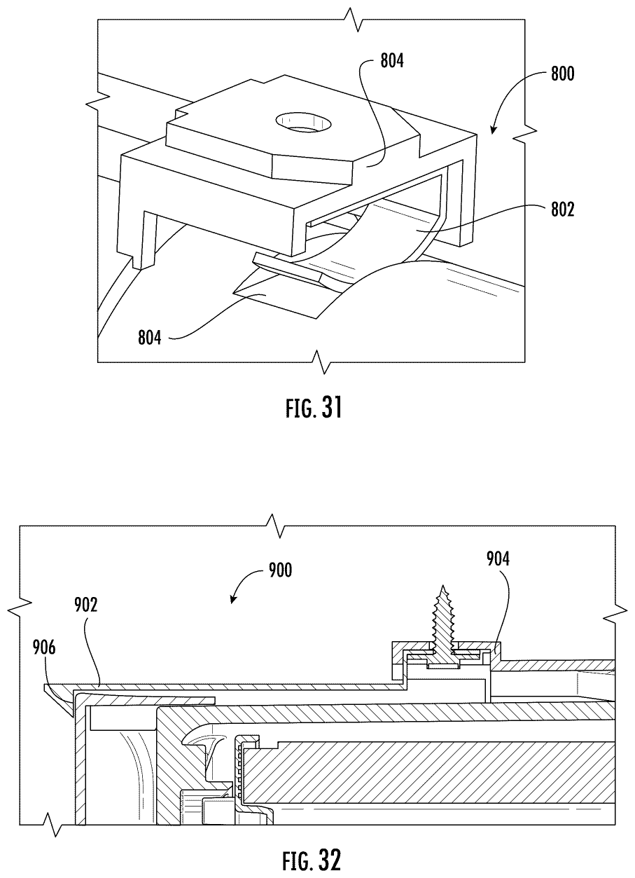

FIG. 32 illustrates a side, cross-section view of a rear retaining device 900 that may be included in the extraction guide 142 and function to retain the filter cartridge 110 within the manifold 140, in accordance with an alternative embodiment of the disclosure. The rear retainer 902 may be affixed to the extraction guide 904 and extend towards the cap at the rear portion of the filter cartridge. In other embodiments, the rear retainer 902 may be structured to be a portion of the manifold 140 and similarly extend towards the cap at the rear portion of the filter cartridge.

The extraction guide 904 may include the features of the extraction guide 142 illustrated in FIGS. 20-21 with the addition of the rear retainer 902 affixed thereto, the extraction guide 142 having been modified with a mounting hole (or having a preexisting mounting hole otherwise repurposed) for mounting the rear retainer 902. The rear retainer 902 may be fabricated of flexible material and includes a latch feature 906 that captures the cap to secure the filter cartridge within the manifold (and relative the extraction guide 904). Accordingly, during the insertion and removal of the filter cartridge, the rear retainer 902 may displace (e.g., flex, rotate, bend, and/or the like) and apply a force to the outer surface of the filter body as it maintains contact with the outer surface of the filter body. Thereafter, once the latch feature 906 of the rear retainer passes over the cap of the filter cartridge, the displacement (e.g., flexing, rotation, bending, and/or the like) in the rear retainer 902 may be relieved, causing the rear retainer 902 to return to a position such that the latch feature 906 captures the cap, preventing unwanted removal or insertion of the filter cartridge.

In some embodiments that include the rear retaining device 900, the flexible prongs 150 illustrated in the filter cartridge of FIG. 14 may be replaced by the rear retaining device 900, with the latch feature 906 holding the filter cartridge in place by securing the filter body to the extraction guide. Accordingly, the manifold 140, such as that which is illustrated in FIGS. 18-24, may receive the filter cartridge by simple alignment of the manifold hole 146 of the manifold 140 and the central opening 138 of the integrated locking head, while the rear retaining device 900 secures the filter cartridge. With the exception of the one or more flexible prongs 150 no longer being present on the integrated locking head due to the alternative securing of the filter cartridge via the rear retaining device 900, the integrated locking head may otherwise be substantially similar to the integrated locking head 120 shown in FIGS. 14-24.

In some embodiments, the rear retaining device 900 may be used alone or in combination with the flexible prongs 150 illustrated in the filter cartridge of FIG. 14 and/or the alternative latching mechanisms described with respect to FIGS. 25-28 and 37.

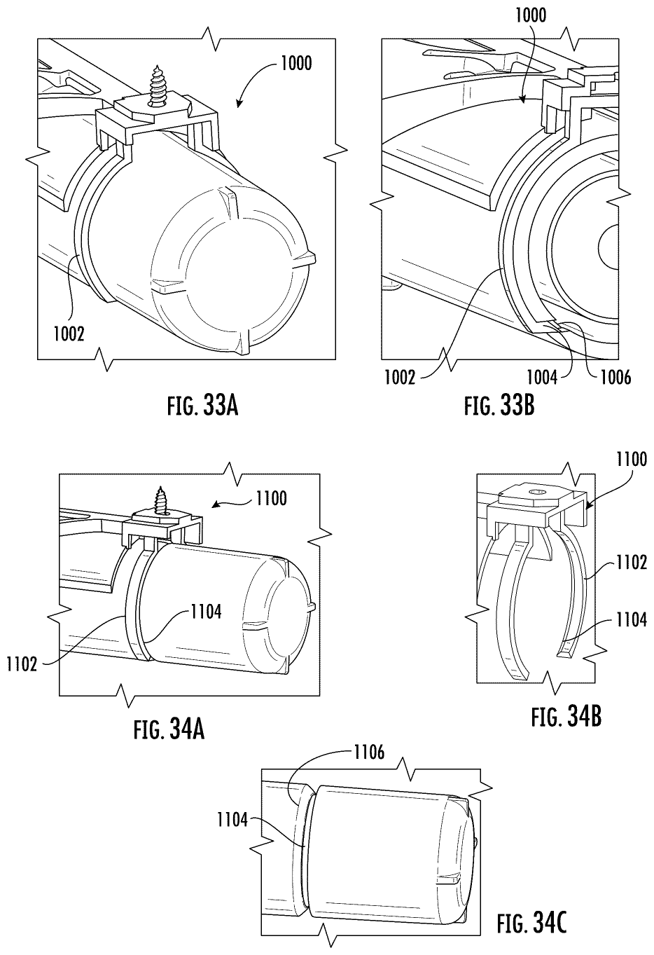

FIGS. 33A and 33B illustrate perspective views of a circumferential retainer 1000 that may be included in the extraction guide 142 and function to retain the filter cartridge 110 within the manifold 140, in accordance with an alternative embodiment of the disclosure. The circumferential retainer includes a thin-walled body 1002 substantially in an arc-shape with at least one finger 1004 extending inwardly. The filter body may include at least one aperture 1006 structured to receive the at least one finger 1004 for securing the filter body. Accordingly, during the insertion and removal of the filter cartridge, the thin-walled body 1002 may displace (e.g., flex, rotate, bend, and/or the like) radially and apply a force to the outer surface of the filter body as it maintains contact with the outer surface of the filter body. Thereafter, once the at least one finger 1004 of the thin-walled body 1002 passes over the at least one aperture 1006 of the filter cartridge, the at least one finger 1004 enters the at least one aperture 1006, causing the displacement (e.g., flexing, rotation, bending, and/or the like) in the thin-walled body 1002 to be relieved while the filter body may be retained as a result of the at least one finger 1004 being retained in the aperture 1006.

The extraction guide may include the features of the extraction guide 142 illustrated in FIGS. 20-21 with the addition of the thin-walled body 1002 affixed thereto, the extraction guide 142 having been modified with a mounting hole (or a preexisting mounting hole otherwise repurposed) for mounting the thin-walled body 1002.

In some embodiments that include the circumferential retainer 1000, the flexible prongs 150 illustrated in the filter cartridge of FIG. 14 may be replaced by the circumferential retainer 100, with the thin-walled body 1002 holding the filter cartridge in place by securing the filter body to the extraction guide. Accordingly, the manifold 140, such as that which is illustrated in FIGS. 18-24, may receive the filter cartridge by simple alignment of the manifold hole 146 of the manifold 140 and the central opening 138 of the integrated locking head, while the circumferential retainer 1000 secures the filter cartridge. With the exception of the one or more flexible prongs 150 no longer being present on the integrated locking head due to the alternative securing of the filter cartridge via the circumferential retainer 1000, the integrated locking head may otherwise be substantially similar to the integrated locking head 120 shown in FIGS. 14-24.

In some embodiments, the circumferential retainer 1000 may be used alone or in combination with the flexible prongs 150 illustrated in the filter cartridge of FIG. 14 and/or the alternative latching mechanisms described with respect to FIGS. 25-28 and 37.

FIGS. 34A-34C illustrate perspective views of a circumferential retainer 1100 that may be attached to the extraction guide 142 and function to retain the filter cartridge 110 within the manifold 140, in accordance with an alternative embodiment of the disclosure. Here, the circumferential retainer includes a thin-walled body 1102 that may include a chamfer 1106, and the portion of the filter body to receive the circumferential retainer 1100 includes a groove 1104 that may include a corresponding chamfer 1106 therein. Instead of the circumferential retainer being seated by insertion of the finger into the aperture such as in FIGS. 33A and 33B, here, the circumferential retainer may be seated by placement within the groove 1104.

The extraction guide may include the features of the extraction guide 142 illustrated in FIGS. 20-21 with the addition of the thin-walled body 1102 affixed thereto, the extraction guide 142 having been modified with a mounting hole (or a preexisting mounting hole otherwise repurposed) for mounting the thin-walled body 1102.

During the insertion and removal of the filter cartridge, the thin-walled body 1102 may displace (e.g., flex, rotate, bend, and/or the like) radially outward and apply a force to the outer surface of the filter body as it maintains contact with the outer surface of the filter body. Thereafter, once the thin-walled body 1102 passes over the groove 1104 of the filter cartridge, the bend or flex in the thin-walled body 1102 may be relieved while the filter body may be retained as a result of the thin-walled body 1102 being retained in the groove 1104.

In some embodiments that include the circumferential retainer 1100, the flexible prongs 150 illustrated in the filter cartridge of FIG. 14 may be replaced by the circumferential retainer 1100, with the thin-walled body 1102 holding the filter cartridge in place by securing the filter body to the extraction guide. Accordingly, the manifold 140, such as that which is illustrated in FIGS. 18-24, may receive the filter cartridge by simple alignment of the manifold hole 146 of the manifold 140 and the central opening 138 of the integrated locking head, while the circumferential retainer 1100 secures the filter cartridge. With the exception of the one or more flexible prongs 150 no longer being present on the integrated locking head due to the alternative securing of the filter cartridge via the circumferential retainer 1100, the integrated locking head may otherwise be substantially similar to the integrated locking head 120 shown in FIGS. 14-24.

In some embodiments, the circumferential retainer 1100 may be used alone or in combination with the flexible prongs 150 illustrated in the filter cartridge of FIG. 14 and/or the alternative latching mechanisms described with respect to FIGS. 25-28 and 37.

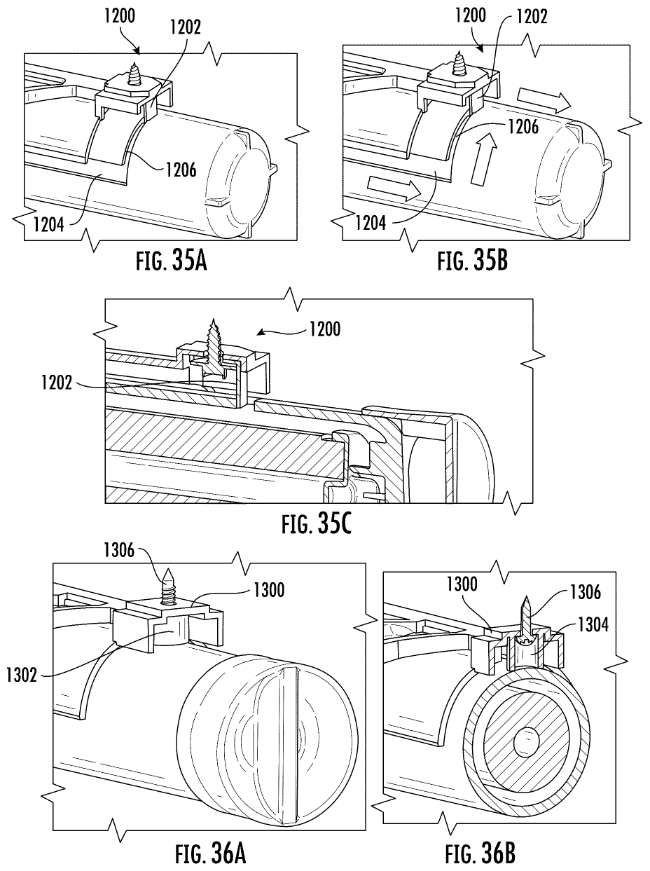

FIGS. 35A-35C illustrate perspective views of a channel retainer assembly 1200 that may be included in the extraction guide 142 and function to retain the filter cartridge 110 within the manifold 140, in accordance with an alternative embodiment of the disclosure. The extraction guide may include a tab-like channel retainer 1202 extending radially towards the filter body.

The extraction guide may include the features of the extraction guide 142 illustrated in FIGS. 20-21 with the addition of the channel retainer 1202 affixed thereto, the extraction guide 142 having been modified with a mounting hole (or a preexisting mounting hole otherwise repurposed) for mounting the channel retainer 1202.

The filter body may then include a longitudinal groove 1204 and a circumferential groove 1206 for receiving the channel retainer 1202. Upon inserting the filter body into the extraction guide, the channel retainer 1202 may be aligned with the longitudinal groove 1204, allowing for the insertion of the filter cartridge in the longitudinal direction. Thereafter, the filter cartridge may be rotated to align the inlet and outlet of the filter cartridge with the corresponding inlet and outlet of the manifold, as described herein with respect to numerous embodiments. During this rotation, the channel retainer 1202 enters the circumferential groove 1206. As a result of the vertical walls that form the circumferential groove 1206 interacting with the channel retainer 1202, the filter cartridge may be prevented from rotation in at least one direction, as well as removal or further insertion in the longitudinal direction.

In some embodiments that include the channel retainer 1200, the flexible prongs 150 illustrated in the filter cartridge of FIG. 14 may be replaced by the channel retainer 1220, with the tab-like channel retainer 1202 holding the filter cartridge in place by securing the filter body to the extraction guide. Accordingly, the manifold 140, such as that which is illustrated in FIGS. 18-24, may receive the filter cartridge by simple alignment of the manifold hole 146 of the manifold 140 and the central opening 138 of the integrated locking head, while the channel retainer 1202 secures the filter cartridge. With the exception of the one or more flexible prongs 150 no longer being present on the integrated locking head due to the alternative securing of the filter cartridge via the channel retainer 1200, the integrated locking head may otherwise be substantially similar to the integrated locking head 120 shown in FIGS. 14-24.

In some embodiments, the channel retainer assembly 1200 may be used alone or in combination with the flexible prongs 150 illustrated in the filter cartridge of FIG. 14 and/or the alternative latching mechanisms described with respect to FIGS. 25-28 and 37.

FIGS. 36A-36B illustrate perspective views and a partial cutaway view of an extraction guide 1300, in accordance with an alternative embodiment of the disclosure. To prevent any thwarting of the retaining mechanisms discussed herein, the extraction guide 1300 may include a hollow screw boss 1302 defining an aperture 1304 for the screw 1306, extending radially towards the filter body. By extending the screw boss to close proximity of where an installed filter cartridge would be held, any insertion of a thwarting device into the aperture 1304 would be much more difficult, as the amount of clearance between the outer surface of the filter body and the free end of the screw boss would be minimal.

In some embodiments, the flexible prongs 150 may be replaced with alternative latching mechanisms. In addition to the embodiments of the alternative latching mechanisms described with respect to FIGS. 25-28, FIG. 37 illustrates a perspective view of a hinged tab filter cartridge integrated locking head 1400, in accordance with an alternative embodiment of the disclosure. The integrated locking head 1400 of the filter cartridge may include at least one hinged tab 1402 that may be rotatably connected to an axle 1404 that extends between two bosses 1406 on a surface of the integrated locking head 1400. The free end of hinged tab 1402 may include a tab portion 1408 that extends radially outwards to engage with a corresponding receptacle of the manifold 140, such as the receptacles 158 illustrated and described with respect to FIGS. 18-24. The pivoting end of the hinged tab may include at least one protrusion 1410 that rests against the filter body in a resting configuration, which thereafter flexes during insertion, providing spring retaining forces to the free end. Additionally, or alternatively, a spring element may be provided to provide counteractive forces during rotation of the hinged tab 1402. Accordingly, during insertion or removal of the filter cartridge, the tab portion 1408 may contact at least one inner surface of the manifold, causing the hinged tab 1402 to displace (e.g., flex, rotate, and/or the like) inwards. Once the tab portion 1408 arrives at the at least one receptacle of the manifold, or other relieved portion of interior portion of the manifold, the compressive forces of the mechanism are relieved, causing the tab portion 1408 to enter the at least one receptacle. The tab portion 1408 may be then restricted by at least one vertical wall of the at least one receptacle, thereby preventing the unwanted removal or insertion of the filter cartridge.

In some embodiments that include the hinged tab filter cartridge integrated locking head 1400, one or more of the flexible prongs 150 illustrated in the filter cartridge of FIG. 14 may be replaced with at least one of the tab portions 1408 shown in FIG. 37, with the tab portion 1408 securing the hinged tab filter cartridge integrated locking head 1400 to the manifold 140. Accordingly, the manifold 140, such as that which is illustrated in FIGS. 18-24, may receive the hinged tab filter cartridge integrated locking head 1400 by latching the tab portion 1408 into the one or more receptacles 158 of the manifold 140. With the exception of one or more flexible prongs 150 being replaced with one or more of the tab portions 1408, the integrated locking head may otherwise be substantially similar to the integrated locking head 120 shown in FIGS. 14-24.

FIG. 38A illustrates a top, rear, left side perspective view of an extraction guide 1500 in accordance with an embodiment of the disclosure. It shall be appreciated that the extraction guide 1500 may be used in combination with the filter cartridge of FIG. 14 and/or the alternative latching mechanisms described with respect to FIGS. 25-37. Furthermore, it shall be appreciated that the extraction guide 1500 may be substantially similar to the extraction guide 142 described with respect to FIGS. 20 and 21, and thus may include various features thereof. Indeed, the extraction guide 1500 will be described hereinafter relative to the extraction guide 142 of FIGS. 20 and 21, primarily illustrating the various features and functionalities that may differentiate the extraction guide 1500 from the extraction guide 142.

The extraction guide 1500 may include a keyway 1502. In some embodiments, and unlike the keyway of the extraction guide 142, the keyway 1502 may include one or more curved sections relative to the longitudinal axis of the filter cartridge 110. In some embodiments, the keyway 1502 may include a first section 1504 being primarily straight and parallel to the longitudinal axis of the filter cartridge, a primarily curvilinear second section 1506 adjacent the first section 1504, and a third section 1508 being primarily straight and parallel to the longitudinal axis of the filter cartridge. Additionally, or alternatively, the first section 1504 may be curvilinear in shape. Additionally, or alternatively, the third section 1508 may be curvilinear in shape.

When a user inserts the filter cartridge 110, the key 122 on the integrated locking head may pass through keyway 1502, and keyway 1502 may guide filter cartridge 110 during insertion. However, unlike the embodiment of FIGS. 20 and 21, the at least one section having curvilinear shape facilitates the rotation of the key 122 during insertion, rather than simply pushing the key 122 along a linear path.

In some embodiments, the extraction guide 142 may include an insertion end 1502a for receiving and guiding the key 122 into the keyway 1502. Contained within the extraction guide 1500 may be an aperture 1510 positioned along a segment of the keyway 1502. This aperture 1510 may be configured such that, when the key 122 of the filter cartridge 110 traverses it, extending beyond the confines of the aperture 1510, the key 122 becomes detectable by a sensor 164, as described previously herein.

In some embodiments, the curvilinear nature of at least one of the first section 1504, second section 1506, and/or third section 1508 may define a curvilinear channel substantially impervious to manipulation by tools, instruments, or other devices inserted into the curvilinear channel with the intent of subverting the function of the sensor 164, such as by actively engaging the sensor 164, or other means of manipulating the appliance into allowing the one or more valves and/or pumps to facilitate water flow into and out of the filter cartridge despite a key 122 not being present in the aperture 1510. Furthermore, the curvilinear channel, having a substantially constant distance between vertical walls throughout portions of the radius of a curve, may prevent the insertion of certain keys that are primarily square or rectangular in shape, depending on the size of the key. Indeed, many such shaped keys may include turning of the filter cartridge in addition to rotation to pass through the curvilinear channel, which may prevented by the size of the cylindrical portions of the extraction guide 1500 relative the outer diameter of the filter cartridge.

In some embodiments, the extraction guide 1500 may further comprise a secondary keyway 1512. The secondary keyway 1512 may be substantially curvilinear in shape and define a curvilinear channel, where the entrance to the secondary keyway 1512 may be connected to the portion of the keyway 1502 including the aperture 1510, and the exit of the secondary keyway 1512 may be connected to the keyway 1502 proximate the insertion end 1502a of the keyway 1502. In some embodiments, the secondary keyway 1512 may be similar to secondary keyway 36, as previously shown and described with respect to FIGS. 6 and 13.

FIG. 38B illustrates a bottom, rear, left side perspective view of an extraction guide 1500 in accordance with an embodiment of the disclosure. Alone or in combination with the other embodiments and features described with respect to the extraction guide 1500, the extraction guide 1500 may include a curved surface 1514 positioned at the terminal end of the keyway proximate to the manifold. The curved surface 1514 may be configured to be substantially free of vertical walls, which may prevent the attachment and retention of any substances or objects within the aperture 1510. Such a configuration may retain the operational intent of the sensor 164, and otherwise prevent such substances or objects within the aperture 1510 from falsely manipulating the sensor 164 into allowing the one or more valves and/or pumps to facilitate water flow into and out of the filter cartridge despite a key 122 not being present in the aperture 1510.

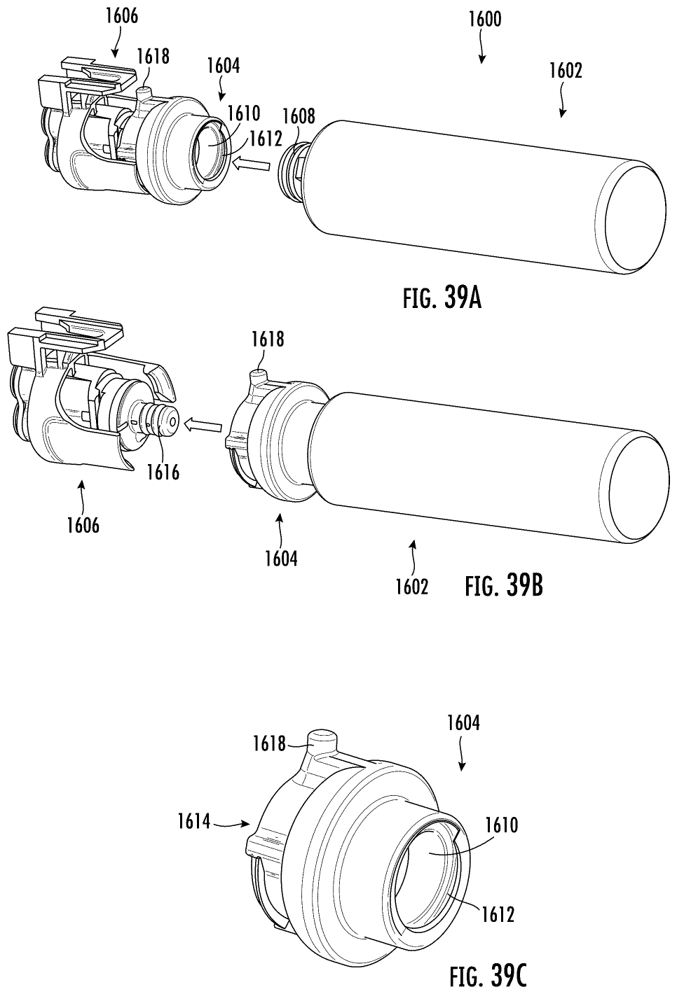

FIGS. 39A-42C illustrate perspective views of adapter systems for use with manifolds of an appliance. While the use of a filter cartridge with an integrated locking head may be described throughout the present disclosure, it shall be appreciated that an adapter may be provided such that one portion of the adapter may be in fluid communication with the fluid inlet and outlet(s) of the manifold (e.g., manifold 40 or manifold 140), while another portion of the adapter may be in fluid communication with a water filter having an interface other than that which can readily be received by the manifold. Some embodiments of adapters may be aftermarket components not otherwise sold with the appliance. Indeed, such adapters may be sold with the purpose of adapting the appliance for use with filter cartridges not otherwise intended for use with the appliance.

For example, FIGS. 39A-39C illustrate an adapter 1604 with fluid inlet and outlet features 1614 structured to be received by the fluid inlet and outlet 1616 of the manifold 1606. The manifold 1606 illustrated in FIGS. 39A-39C may be substantially similar to the manifold 40 disclosed in FIGS. 1-13, although various features may be added or removed and/or combined with features disclosed related to other manifolds described herein. The adapter 1604 may include internal corridors, channels, or conduits to receive water from or provide water to the manifold 1606. The fluid inlet and outlet features 1614 may be in fluid communication with a coupling 1610, which may include corresponding inlet and outlet features in fluid communication with a water filter 1602. As such, the adapter 1604 may include threads 1612, or any other mechanism for creating a water-tight connection between the water filter 1602 and the adapter 1604, such as compression fittings, flared connections, gasket seals, o-ring seals, push-to-connect fittings, quick-disconnect fittings, expansion joints, and/or the like.

For installation, the adapter 1604 may be placed in the manifold 1606. In some embodiments, a key 1618 may trigger a sensor 164 to alert the appliance that a water filter may be present. Thereafter, a port 1608 of the water filter 1602 may be brought into the coupling 1610 and the water filter 1602 may be affixed to the coupling 1610 using threads 1612 such that the filter media of the water filter 1602 may be in fluid communication with the fluid inlet and outlet 1616 manifold 1606.

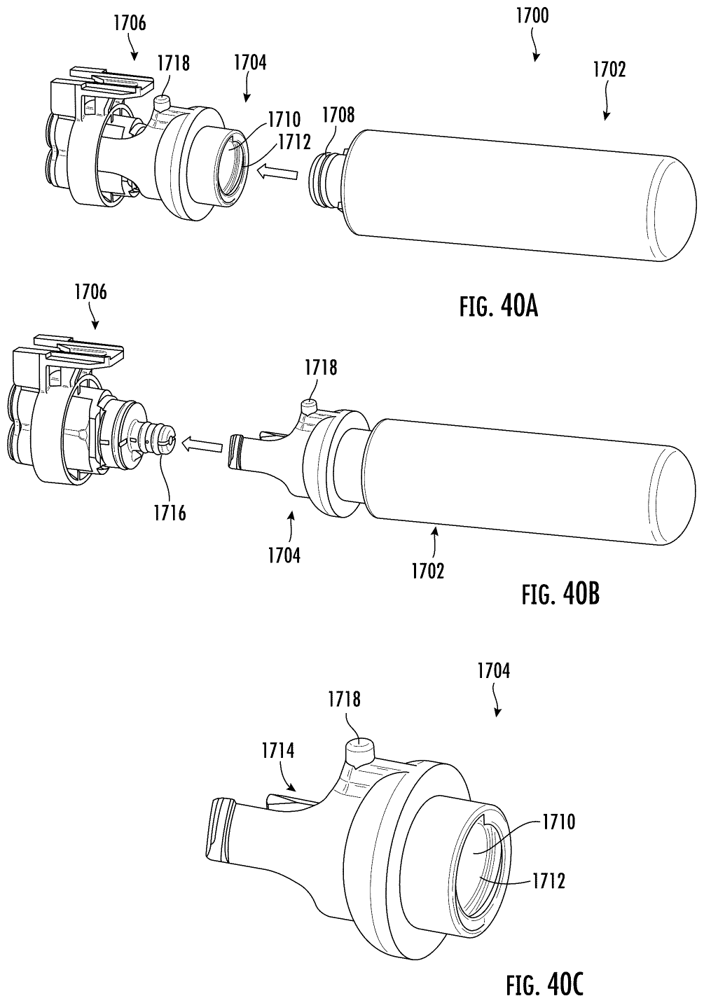

As another non-limiting example, FIGS. 40A-40C illustrate an adapter 1704 with fluid inlet and outlet features 1714 structured to be received by the fluid inlet and outlet 1716 of the manifold 1706. The manifold 1706 illustrated in FIGS. 40A-40C may be substantially similar to the manifold 140 disclosed in FIGS. 14-24, although various features may be added or removed and/or combined with features disclosed related to other manifolds described herein. The adapter 1704 may include internal corridors, channels, or conduits to receive water from or provide water to the manifold 1706. The fluid inlet and outlet features 1714 may be in fluid communication with a coupling 1710, which includes corresponding inlet and outlet features in fluid communication with a water filter 1702. As such, the adapter 1704 may include threads 1712, or any other mechanism for creating a water-tight connection between the water filter 1702 and the adapter 1704, such as compression fittings, flared connections, gasket seals, o-ring seals, push-to-connect fittings, quick-disconnect fittings, expansion joints, and/or the like.

For installation, the adapter 1704 may be placed in the manifold 1706 (or other manifolds described herein). In some embodiments, a key 1718 may trigger a sensor 164 to alert the appliance that a water filter may be present. Thereafter, a port 1708 of the water filter 1702 may be brought into the coupling 1710, and the water filter 1702 may be affixed to the coupling 1710 using threads 1712 such that the filter media of the water filter 1702 may be in fluid communication with the fluid inlet and outlet 1716 manifold 1706.

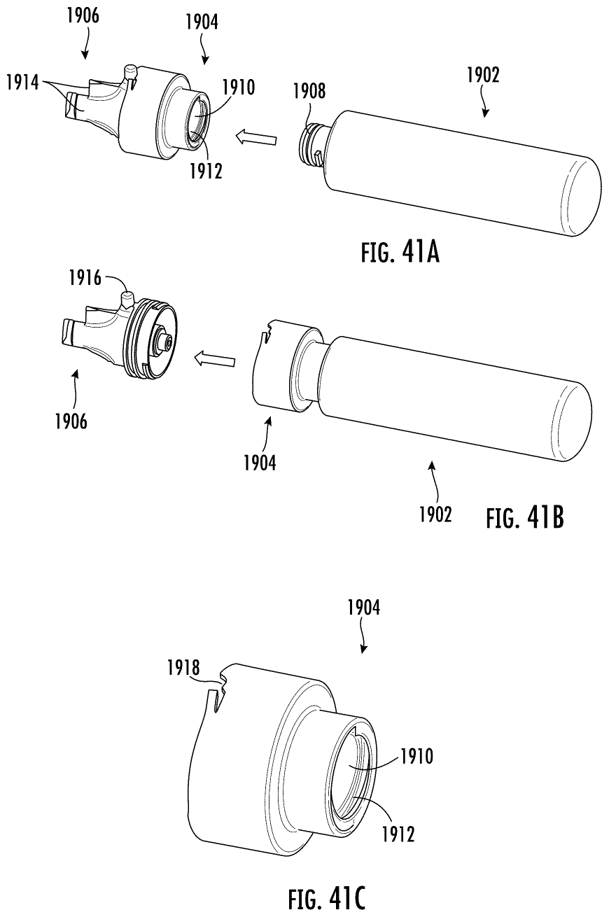

FIGS. 41A-41C illustrate an adapter 1904 with fluid inlet and outlet features 1714 structured to be received by a locking head 1906 and allow for the use of another water filter. The locking head 1906 illustrated in FIGS. 41A-41C may be substantially similar to the integrated locking heads disclosed in FIGS. 1, 14, or any other embodiment described herein. The adapter 1904 may include internal corridors, channels, or conduits to receive water from or provide water to the locking head 1906. The adapter 1904 may include a coupling 1910, which includes corresponding inlet and outlet features in fluid communication with a water filter 1902. As such, the adapter 1904 may include threads 1912, or any other mechanism for creating a water-tight connection between the water filter 1902 and the adapter 1904 via the port 2908, such as compression fittings, flared connections, gasket seals, o-ring seals, push-to-connect fittings, quick-disconnect fittings, expansion joints, and/or the like. Similarly, the adapter 1904 may include means for creating a water-tight connection between the locking head 1906 and the adapter 1904. As such, in some embodiments, the locking head 1906 may include features to sealingly receive the adapter 1904, such as threads, connectors, or the like.

For installation, the adapter 1904 may be placed onto a portion of the locking head 1906. They keyslot 1918 may be aligned with a corresponding key 1916 of the locking head 1906. In some embodiments, the keyslot 1918 may attach to the key 1916 such that the adapter 1904 may be locked in position relative to the locking head 1906. Prior to, or after the placement of the adapter 1904 onto the locking head 1906, the water filter 1902 may be attached to the adapter 1904 such that the water filter 1902 may be in fluid communication with the locking head 1906. Accordingly, the adapter 1904 may be attached to the locking head 1906 and remain attached thereto during replacement of the water filter 1902. Alternatively, the adapter 1904 may remain attached to the water filter 1902 during replacement of the water filter 1902.

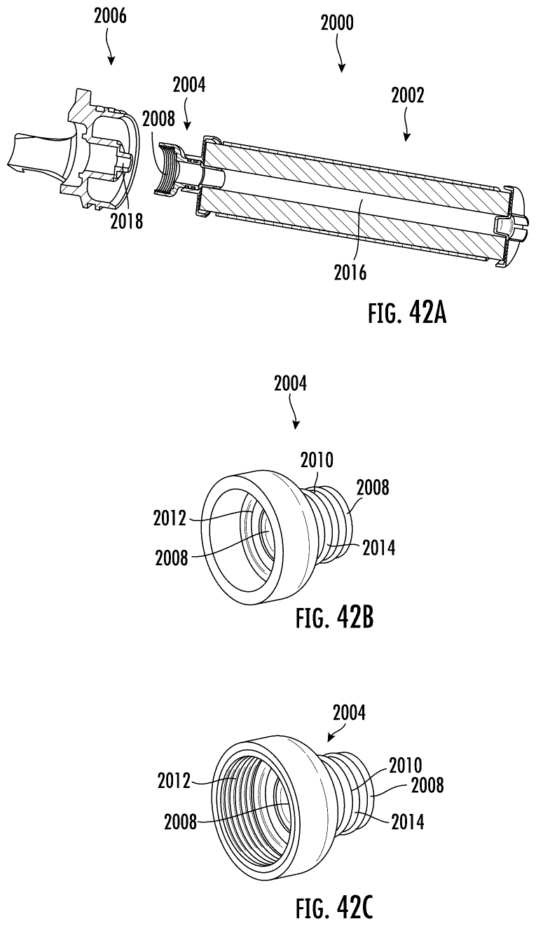

Alternatively, FIGS. 42A-42C illustrate an adapter 2004 for a filter media structured to be received by a locking head 1906 and allow for the use of another filter media. While the adapter 1904 described with respect to FIGS. 42A-42C is attached to external features of the water filter 1902, such as the port 1908, to provide for the use of other filter cartridges, it shall be appreciated that other filter media 2002 may be adapted for use with the locking head 1906. Thus, the adapter 2004 may allow for such other filter media to be used internal to, and independent of, the filter body.

The locking head 2006 illustrated in FIGS. 42A-42C may be substantially similar to the integrated locking heads disclosed in FIGS. 1, 14, or any other embodiment described herein. The adapter 2004 may include a head coupling 2012 for receiving a portion of the locking head 2006, and a filter coupling 2014 for being received by a corresponding channel 2016 of the filter media 2002. The adapter 2004 may include an internal aperture 2008 extending between the head coupling 2012 and the filter coupling 2014 to transport water from or transport water to the locking head 2006 and/or the filter media 2002.

In some embodiments, the head coupling 2012 of the adapter 2004 may include a coupling such as threads or any other mechanism for creating a water-tight connection between the head 2006 and the adapter 2004, such as compression fittings, flared connections, gasket seals, o-ring seals, push-to-connect fittings, quick-disconnect fittings, expansion joints, and/or the like. Similarly, the filter coupling 2014 of the adapter 2004 may include threads, compression fittings, flared connections, gasket seals, o-ring seals, push-to-connect fittings, quick-disconnect fittings, expansion joints, and/or the like for creating a water-tight connection between the filter media 2002 the adapter 2004.

For installation, the filter coupling 2014 of the adapter 2004 may be attached to a channel of the filter media 2002. Thereafter, the head coupling 2012 may be attached to a portion of the locking head 2006, such that the filter media 2002 may be in fluid communication with the locking head 2006. Accordingly, the adapter 2004 may be attached to the locking head 2006 and remain attached thereto during replacement of the filter media 2002. Alternatively, the adapter 2004 may remain attached to the filter media 2002 during replacement of the filter media 2002.

Although many embodiments of the present disclosure have just been described above, the present disclosure may be implemented in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

### INCORPORATION BY REFERENCE

To supplement the present disclosure, each of the following patents, patent publications, and patent applications, is incorporated herein by reference in its entirety: U.S. Pat. Nos. 10,022,658B2; 10,010,820B1; 9,937,451B2; 8,950,052B2; 8,845,896B2; 8,591,736B2; 8,413,818B1; 8,356,716B1; 7,610,932B2; 7,147,773B2; 7,000,894B2; USRE46554E1; U.S. Pat. Nos. 7,799,220B2; 8,182,699B2; 9,872,584B2; USD772379S1; USD472299S1; U.S. Pat. Nos. 9,687,762B2; 9,345,995B2; 5,907,958A; 9,366,388B2; 10,603,612B2; 10,913,020B2; 10,905,989B2; 10,272,370B2; 9,242,195B2; 9,027,361B2; 8,955,349B2; 10,946,319B2; 9,993,757B2; 10,737,206B2; USD735294S1; U.S. Pat. Nos. 9,901,854B1; 7,823,407B2; 9,494,362B2; 9,487,414B2; 8,496,823B2; 9,320,993B2; 10,967,313B2; U.S. Published Application Nos. 20120211412A1; 20180056216A1; 20180304181A1; 20210178297A1; 20150157967A1; 20100000919A1; 20210299600A1; 20200139280A1; 20150258476A1; U.S. patents application Ser. Nos. 29/786,024; 29/786,025; 29/786,026; 29/786,027; 17/333,124; WIPO PCT Application Nos. PCT/US23/79246; PCT/US23/79242; and U.S. Provisional Application Ser. Nos. 63/423,971; 63/423,976; 63/541,316.

What is claimed is:

1. A mechanical interlock system, comprising:
a filter cartridge comprising:
a filter body having a first end, a second end, and a longitudinal axis;
a fluid inlet and outlet at the first end of the filter body; and
an integrated locking head on the first end of the filter body, wherein the integrated locking head comprises:
a key extending radially outward from the integrated locking head; and
at least one displaceable latch feature extending longitudinally from the integrated locking head; and
a manifold for receiving the filter cartridge, the manifold comprising:
at least one receptacle on an inner surface of the manifold, the at least one receptacle structured for receiving the at least one displaceable latch feature, preventing rotation of the filter cartridge in a first direction, and permitting rotation of the filter cartridge in a second direction, wherein the at least one receptacle is structured to:
prevent, after the at least one displaceable latch feature has been received by the at least one receptacle, movement of the filter cartridge in a direction along the longitudinal axis that is opposite an insertion direction;
prevent rotation of the filter cartridge in the first direction; and
permit rotation of the filter cartridge in the second direction;
an extraction guide for receiving the key, wherein the extraction guide comprises:
a primary keyway; and
a secondary keyway, wherein the secondary keyway has an entry end and an exit end, and wherein the exit end of the secondary keyway connects to the primary keyway.

2. The mechanical interlock system of claim 1, wherein, during insertion of the filter cartridge into the manifold, the key passes through the primary keyway.

3. The mechanical interlock system of claim 1, wherein the primary keyway comprises a curvilinear channel.

4. The mechanical interlock system of claim 1, wherein, when the key is positioned in the primary keyway, the primary keyway prevents rotation of the filter cartridge, aligns the at least one displaceable latch feature with the at least one receptacle, and aligns the fluid inlet and outlet of the filter cartridge with a fluid connector of the manifold, and wherein the manifold is positioned in an appliance.

5. The mechanical interlock system of claim 1, wherein:
an end portion of the primary keyway comprises a sidewall configured to interact with the key to prevent rotation of the filter cartridge in the first direction, and wherein the end portion permits rotation of the filter cartridge in the second direction;
after insertion of the filter cartridge into the manifold, a stop element of the at least one receptacle interacts with the at least one displaceable latch feature to prevent rotation of the filter cartridge in the first direction; and
after insertion of the filter cartridge into the manifold, a curved transition surface of the manifold interacts with the at least one displaceable latch feature to permit rotation of the filter cartridge in the second direction.

6. The mechanical interlock system of claim 5, wherein during insertion of the filter cartridge into the manifold:
a latch feature of the at least one displaceable latch feature interacts with a curved interior surface of the manifold, prior to being received by the at least one receptacle to force the at least one displaceable latch feature to displace radially inward as a result.

7. The mechanical interlock system of claim 5, wherein during removal of the filter cartridge from the manifold and counterclockwise rotation of the filter cartridge in the manifold:
the at least one displaceable latch feature interacts with the curved transition surface of the at least one receptacle to force the at least one displaceable latch feature to displace radially inward; and
the key rotates toward the entry end of the secondary keyway.

8. A filter cartridge, comprising:
a filter body having a first end, a second end, and a longitudinal axis;
a fluid inlet and outlet at the first end of the filter body; and
an integrated locking head on the first end of the filter body, wherein the integrated locking head comprises at least one displaceable latch feature extending longitudinally from the integrated locking head, wherein the at least one displaceable latch feature is configured to be received by at least one receptacle on an inner surface of a manifold, and wherein the at least one receptacle comprises:
a stop element at a first end of the at least one receptacle; and
a curved transition surface at a second end of the at least one receptacle.

9. The filter cartridge of claim 8, wherein the at least one displaceable latch feature comprises a latch feature, wherein insertion of the filter cartridge into the manifold causes the at least displaceable latch feature to interact with a curved interior surface of the manifold, prior to being received by the at least one receptacle, to force the at least one displaceable latch feature to displace radially inward as a result.

10. The filter cartridge of claim 9, wherein, after insertion of the filter cartridge into the manifold, the latch feature is structured to sit within the at least one receptacle and prevent movement of the filter cartridge in a direction along the longitudinal axis that is opposite an insertion direction.

11. The filter cartridge of claim 8, wherein, after insertion of the filter cartridge into the manifold, the at least one displaceable latch feature is structured to interact with the stop element of the at least one receptacle to prevent rotation of the filter cartridge in a first direction.

12. The filter cartridge of claim 8, wherein, after insertion of the filter cartridge into the manifold, the at least one displaceable latch feature is structured to interact with the curved transition surface of the at least one receptacle to permit rotation of the filter cartridge in a second direction.

13. The filter cartridge of claim 12, wherein, during removal of the filter cartridge from the manifold and during rotation of the filter cartridge in the second direction, the at least one displaceable latch feature interacts with the curved transition surface of the at least one receptacle to force the at least one displaceable latch feature to displace radially inward.

14. The filter cartridge of claim 8, wherein the at least one displaceable latch feature is a first displaceable latch feature, wherein the integrated locking head comprises a second displaceable latch feature, and wherein the first displaceable latch feature and the second displaceable latch feature are diametrically opposed relative an outer surface of the integrated locking head.

15. The filter cartridge of claim 8, wherein the integrated locking head comprises a key extending radially outward from the integrated locking head.

16. The filter cartridge of claim 15, wherein, during insertion of the filter cartridge into a manifold, the key is structured to pass through a primary keyway of an extraction guide of the manifold.

17. The filter cartridge of claim 15, wherein, when the key is positioned in a primary keyway of an extraction guide of a manifold, the primary keyway is structured to prevent rotation of the filter cartridge.

18. The filter cartridge of claim 15, wherein the key has a cylinder shape and a radially-outward-facing surface that is sloped radially inward from a center of the radially-outward-facing surface.

19. The filter cartridge of claim 8, wherein the at least one displaceable latch feature comprises a first curved surface having a first radius, and wherein the at least one receptacle comprises a second curved surface having a second radius at an interface surface receiving the first curved surface, wherein the second radius is smaller than the first radius.

20. The filter cartridge of claim 8, wherein the at least one displaceable latch feature comprises a first surface and the at least one receptacle comprises a second surface, wherein in an installed configuration, the first surface and the second surface define an interface surface and at least one gap between the first surface and the second surface.

21. A method, comprising:
providing a filter cartridge comprising an integrated locking head, wherein the integrated locking head comprises at least one displaceable latch feature, and wherein the at least one displaceable latch feature comprises a latching mechanism;
inserting, in an insertion direction, the filter cartridge into a manifold of an appliance, wherein the manifold comprises at least one receptacle structured to receive the at least one displaceable latch feature; and
while inserting, and prior to engaging the latching mechanism with the at least one receptacle, forcing the at least one displaceable latch feature to displace radially inward.

22. The method of claim 21, comprising, while inserting, overcoming a force applied to the integrated locking head in an extraction direction opposite the insertion direction.

23. The method of claim 21, wherein the integrated locking head comprises a key extending radially outward from the integrated locking head, the method comprising, before inserting, aligning the key with a keyway of the manifold.

24. The method of claim 21, comprising, while the at least one displaceable latch feature is positioned in the at least one receptacle:
preventing movement of the filter cartridge in an extraction direction opposite the insertion direction; and
preventing, with a stop element of the at least one receptacle, rotation of the filter cartridge in a first direction.

25. The method of claim 24, comprising, while the at least one displaceable latch feature is positioned in the at least one receptacle, permitting, with a curved transition surface of the at least one receptacle, rotation of the filter cartridge in a second direction opposite the first direction.

26. The method of claim 25, comprising, after positioning the at least one displaceable latch feature in the at least one receptacle, rotating the filter cartridge in the second direction.

27. The method of claim 26, comprising, while rotating the filter cartridge in the second direction, forcing, with the curved transition surface of the at least one receptacle, the at least one displaceable latch feature to displace radially inward and disengage from a vertical surface of the at least one receptacle.

28. The method of claim 27, comprising, after forcing the at least one displaceable latch feature to displace radially inward and disengage from a vertical surface of the at least one receptacle, pushing the integrated locking head in an extraction direction opposite the insertion direction.

29. The method of claim 27, wherein the integrated locking head comprises a key extending radially outward from the integrated locking head, the method comprising, after forcing the at least one displaceable latch feature to displace radially inward and disengage from a vertical surface of the at least one receptacle, pulling the filter cartridge in an extraction direction opposite the insertion direction causing the key to enter a secondary keyway, of the manifold, that intersects with a primary keyway, of the manifold, through which the key passed while inserting the filter cartridge into the manifold.

30. The method of claim 29, comprising:
while pulling the filter cartridge in the extraction direction, pulling the key through the secondary keyway and into the primary keyway.

31. The method of claim 30, comprising:
while pulling the filter cartridge in the extraction direction, pulling the key through the primary keyway; and
withdrawing the filter cartridge from the appliance.
